(19) United States
(12) Patent Application Publication
(10) Pub. No.: US 2015/0046349 A1
(43) Pub. Date: Feb. 12, 2015

(54) Mobile Platform for Legal Process

(71) Applicants: Thomas J. Michael, JR., Fair Oaks, PA (US); Amy D. Lathers, Fair Oaks, PA (US); Thomas J. Michael, Leetsdale, PA (US)

(72) Inventors: Thomas J. Michael, JR., Fair Oaks, PA (US); Amy D. Lathers, Fair Oaks, PA (US); Thomas J. Michael, Leetsdale, PA (US)

(21) Appl. No.: 14/456,837

(22) Filed: Aug. 11, 2014

Related U.S. Application Data
(60) Provisional application No. 61/864,690, filed on Aug. 12, 2013.

(51) Int. Cl. H04M 3/42; G06Q 50/18

(52) U.S. Cl. CPC H04M 3/42; G06Q 50/18
USPC 705/311

(57) ABSTRACT

A machine based system for a legal process is provided that includes a memory and a processor. The memory may store settlement authority, and the processor may accept input on whether a settlement offer was accepted. The processor may cause the decision on whether the settlement offer was accepted to be stored in the memory. A display may be included that that displays the settlement authority. A camera may be used to capture an image of a document that is stored in the memory.

### CROSS REFERENCE TO RELATED APPLICATION

This application claims the benefit of U.S. Application Ser. No. 61/864,690 filed on Aug. 12, 2013 and entitled, “Mobile Platform for Collection Litigation System.” U.S. Application Ser. No. 61/864,690 is incorporated by reference herein in its entirety for all purposes.

### FIELD OF THE INVENTION

The present invention relates to a mobile platform that firms may use for purposes of conducting legal processes such as collection litigation, bankruptcy litigation, or transactional legal work. More particularly, the present application involves a system for tracking events assigned to particular cases and facilitates communication and tracking between firms and appearance attorneys that handle various cases.

### BACKGROUND

In the course of conducting business, it is inevitable that some consumers fail to pay for the goods or services they purchase. This failure to pay creates a debt owed to the company or individual that provides the goods or services and, depending on the amount of debt and the cost and ability to recover the debt, may cause the company or individual to pursue the debtor. One manner in which a creditor may seek to recover a debt owed is through the hiring of a debt collection agency. The debt collection agency may, on behalf of the creditor, send collection letters and make telephone calls to the debtor in an attempt to collect the debt. The Fair Debt Collection Practices Act (FDCPA) prohibits collection agencies from using false statements, abusive practices, and unfair acts to collect debts from consumers. Improper acts performed by a collection agency in violation of the FDCPA may be imputed to the creditor and may subject the creditor to fines, actual damages, punitive damages, and attorney fees.

If the collection agency is unable to collect on the debt, the creditor may hire the services of a law firm to file a lawsuit against the debtor to collect the debt through legal channels. The law firm's efforts will also be subject to the FDCPA and thus the law firm should have procedures in place to ensure that legal proceedings are conducted in a consistent and proper manner to comply with the act. Other challenges facing collection law firms when seeking to collect debt may include debtors located in varying jurisdictions thus requiring the hiring of local appearance attorneys to actually go into court to appear on behalf of the collection law firm and creditor. Use of appearance attorneys thus adds another layer of complexity to the overall process.

Creditors may want appearance attorneys to perform certain tasks and represent themselves in a particular way when representing them in court. Although creditors may be any company or individual, a large portion of creditors are banks and credit card companies. Debtors may be companies or individuals. When a bank or credit card company sues an individual to collect a debt, they are in fact suing their customer. For this reason, banks and credit card companies when collecting debts sometimes refer to debtors as “clients” and may want their appearance attorney to represent them in a manner that is conducive to furthering the goals and policies of the bank or credit card company. It may be the case that appearance attorneys do not act in a way, or perform tasks in a way, desired by the creditor due to a large amount of cases and representation of the creditor that the appearance attorney may have never even met.

Additionally, banks and credit card companies may be multi-layered entities with multiple decision makers that each have their own manner of authorizing settlement of cases. Appearance attorneys may not know how much they are authorized to settle particular cases for and may not know who in the bank or credit card company to contact to authorize settlement. All of these factors influence the quality of the legal collection process and may result in less than optimal results for the creditor. As such, there remains room for variation and improvement within the art.

### DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a diagrammatic view of users of the machine based system.

FIG. 1a is a diagrammatic view of users of the machine based system in an alternative exemplary embodiment.

FIG. 2 is a home page of an appearance attorney.

FIG. 3 is a dashboard of the appearance attorney.

FIG. 4 is a dashboard of a creditor.

FIG. 5 is a home page of a collection law firm.

FIG. 6 is a dashboard of the collection law firm.

FIG. 7 is a home page of a system administrator.

FIG. 8 is a dashboard of the system administrator.

FIG. 9 is a screen shot of a home page.

FIG. 10 is a screen shot of a new case screen.

FIGS. 11A and 11B are a screen shot of a find case screen.

FIGS. 12A and 12B are flowcharts of dynamic outcomes of events.

FIG. 13 is a screen shot of a find events screen.

FIG. 14 is a screen shot of an events results screen.

FIG. 15 is a screen shot of a selected event screen.

FIG. 16 is screen shot of a submit new event screen.

FIG. 17 is a creditor/plaintiff profile.

FIG. 18 is an attorney appearance package.

FIG. 19 is an audit report.

FIG. 20 is an event report.

FIG. 21 is a mobile device display of an appearance attorney check-in page.

FIG. 22 is a mobile device display of the appearance attorney case display page.

FIG. 23 is a mobile device display of defense attorney information.

FIG. 24 is a flow chart of five modules of the machine based system.

FIG. 25 is a front view of components of the machine based system such as a user computer, a mobile device, a collection litigation server, and a router.

FIG. 26 is a schematic view of a transactional system.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a machine based system 10 that can be used in the legal industry to manage litigation and/or transactional legal work. The machine based system 10 can be used for collection litigation, bankruptcy litigation, mortgage foreclosure litigation, and structured settlement litigation. Additionally or alternative, the machine based system 10 can be used for a legal process that is transactional legal work such as work in the oil and gas industry, or work regarding the drafting and filing of briefs and motions. For sake of example, the machine based system 10 will be described with reference to implementation with collection litigation. The present invention provides for a machine based system 10 that is used by collection law firms 14 and appearance attorneys 16 to keep track of cases, procedures, fees and other collection litigation items when representing creditors 12. The machine based system 10 may allow the appearance attorney 16 to track updates in various cases so that the collection law firm 14 and even the creditor 12 can have access to this information. The appearance attorney 16 may be provided with best practices instructions and organized and updated settlement information for various cases handled by the appearance attorney 16. A mobile application may be provided to the appearance attorney 16 in some exemplary embodiments.

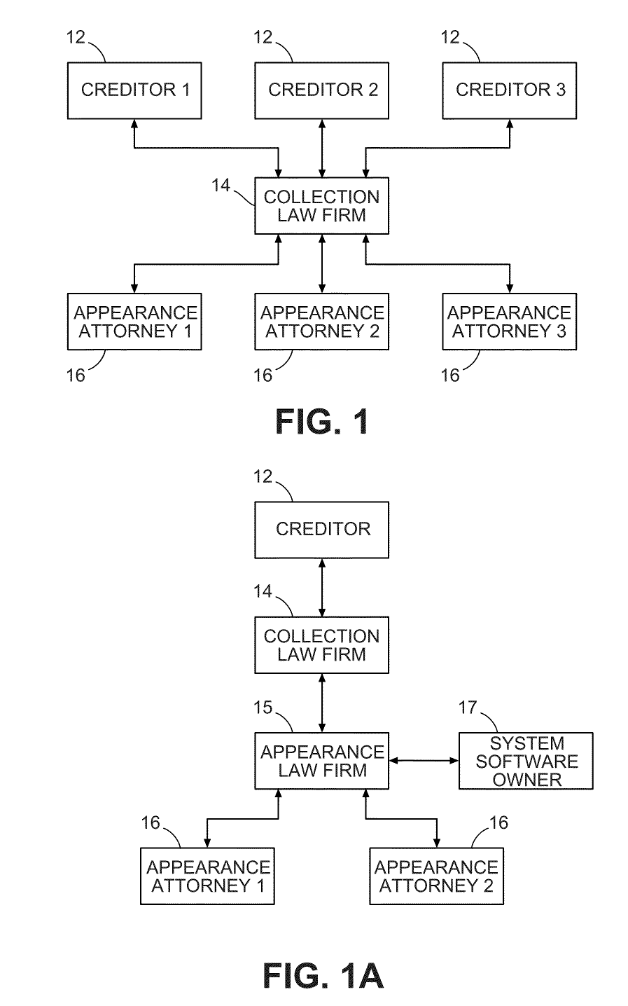

The machine based system 10 can be used by multiple parties such as appearance attorneys 16, collection law firms 14, creditors 12, and a system administrator. With reference to FIG. 1, the collection law firm 14 may be hired by a number of different creditors 12 to collect debts on their behalf through litigation. Although three creditors 12 are illustrated, any number may be present in other embodiments. Further, although a single collection law firm 14 is employed, any number of collection law firms 14 could be hired by the creditors 12. The collection law firm 14 in turn hires a number of appearance attorneys 16, directly or indirectly through a company or appearance law firm 15, who physically appear in court on behalf of the collection law firm 14. The appearance attorneys 16 are licensed in the particular jurisdiction or court where they are appearing on behalf of the collection law firm 14.

With reference to FIG. 1a, another arrangement of the users of the machine based system 10 is illustrated in which a creditor 12 again engages a collection law firm 14 for purposes of collecting on a debt. The collection law firm 14 may engage an appearance law firm 15. The appearance law firm 15 may be licensed in the particular jurisdiction where the debt is to be collected. In turn, the appearance law firm 15 may hire one or more appearance attorneys 16 that physically appear at courthouses and other locations. The machine based system 10 may include software that can be owned by an owner 17. The owner 17 may license the software to the appearance law firm 15. The license may allow the appearance law firm 15 and other entities 12, 14 and 16 to use the software, and the license may be an exclusive license in some exemplary embodiments.

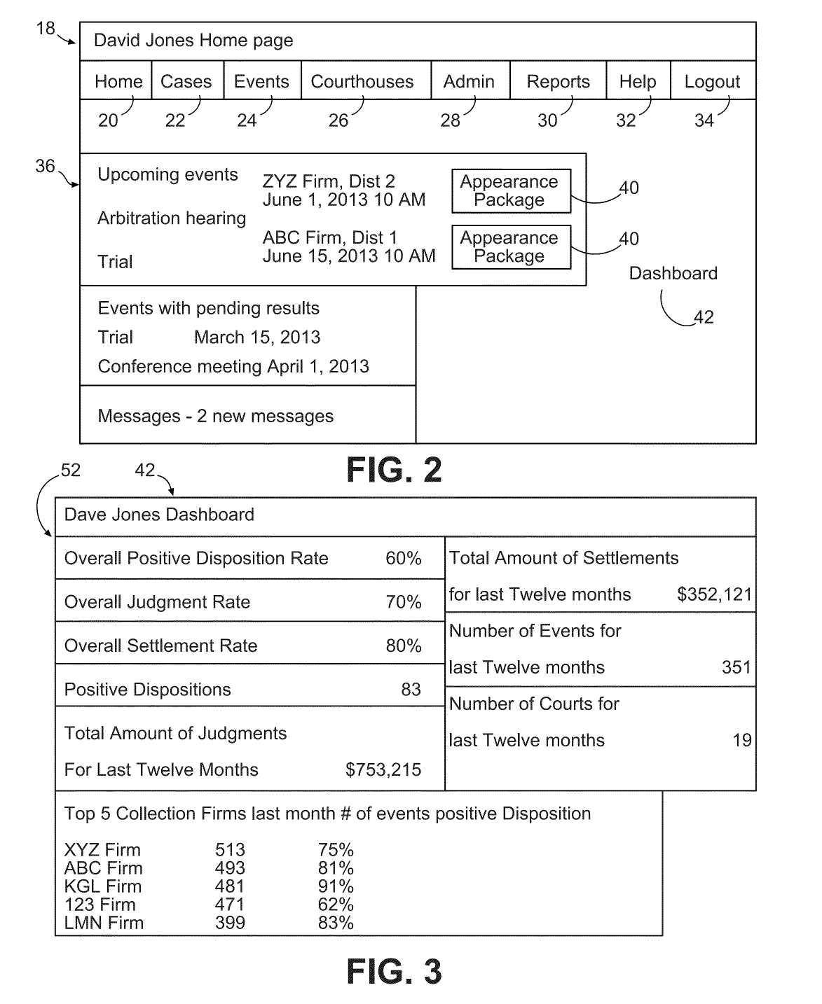

All of the entities in FIGS. 1 and 1a may have access to the machine based system 10. In other arrangements, one or more entities will not have access to the machine based system 10. A unique login may be provided to each user, and the user may use a computer to access a webpage and enter in a password. An appearance attorney 16 successfully logging into the machine based system 10 may be presented with an appearance attorney home page 18 as shown in FIG. 2.

The home page 18 includes a series of tabs and a newsfeed 36 that includes a dashboard of the appearance attorney 42. The series of tabs include a home tab 20, a case tab 22, an events tab 24, a courthouse tab 26, an administration tab 28, a reports tab 30, a help tab 32, and a logout tab 34. As the user navigates through the machine based system 10, the various tabs will be presented to the user and if a particular one is selected, items associated with that particular tab will then be presented to the user. Clicking on the home tab 20 will cause the home page 18 shown in FIG. 2 to be presented.

The home page for the appearance attorney 18 also includes the newsfeed 36 that has a series of news items. A list of upcoming events may be presented to the user and can be sorted by date and time. Up to 20, or more in other arrangements, upcoming events can be presented in the newsfeed 36, although only two are shown in the exemplary embodiment of FIG. 2. Each of the events listed in the upcoming events includes a caption, the court in which the event is occurring, the name of the collection firm, and the date and time of the event. The upcoming events may be sorted by date and time. Also included with each of the upcoming events is an appearance package button 40. If the appearance attorney 16 dicks on the appearance package button 40, a printout will occur that provides the appearance attorney 16 with information relevant to the particular upcoming event and how the creditor 12 and/or collection law firm 14 would like the appearance attorney 16 to handle himself or herself at the event. If the appearance attorney 16 does click on the appearance package button 40, a green checkmark will then be presented next to the event to show that the documents/appearance package for a particular event has been printed.

The newsfeed 36 also includes a list of events with pending results. This list may be sorted by days that are delinquent such that the oldest results are listed first. If a user clicks on one of the events in the events list with pending results, a purple highlight with popup access to the event record may be presented to the user. The newsfeed 36 also includes a message field that informs the appearance attorney 16 of the presence of new messages, or old messages, for review.

The newsfeed 36 also includes a dashboard 42 of the appearance attorney. The full dashboard 42 of the appearance attorney is shown in FIG. 3. The full dashboard 42 includes a series of data items 52. All or only a portion of the data items 52 can be included in the dashboard 42 that is displayed on the home page 18. However, the appearance attorney upon clicking on the reports tab 30 may be presented with a dashboard item that if clicked will then allow the appearance attorney 16 to view the full dashboard 42 shown in FIG. 3.

As stated, the dashboard 42 includes a series of data items 52 and the first data item 52 that is shown is the overall positive disposition rate. This percentage may be the percentage of cases with a “positive” disposition that have occurred in the last 12 months for the appearance attorney 16. The data items 52 also include an overall judgment rate which may be the percent of cases with a “judgment/award for the plaintiff” and a “consent judgment without payment plan” that have occurred in the last 12 months. An overall settlement rate is also included in the data items 52 and is displayed as a percentage. The overall settlement rate may be the percent of cases with a “settlement agreement without judgment/award” and a “consent judgment with payment plan” that have occurred in the last 12 months.

The data item 52 also includes a total number of positive dispositions that is listed as a numerical number. A total dollar amount of judgments for the last 12 months is also provided. The total dollar amount of judgments is a dollar amount of the “judgment/award for plaintiff” and the “consent judgment without payment plan”. The total dollar amount of judgments may be provided on a monthly basis such that if the user clicks on this data item 52 a separate popup window occurs that shows the total dollar amount of judgments that have occurred for each month for the last 12 months. The dashboard 42, however, shows the total amount.

The data items 52 also include in the right hand column at the top a dollar amount of settlements that have occurred in the last 12 months. This amount is the total for the last 12 months and is displayed in a dollar amount. The total dollar amount of settlements includes the “settlement agreement without judgment/award” and the “consent judgment with payment plan.” The user may click on this data item 52 and be presented with a separate popup window that shows a monthly breakdown of the total dollar amount of settlements for each month for the last 12 months.

The data items 52 further include the number of events for the last 12 months. Clicking on the number of events again displays a separate popup window that shows the number of events per month for the last 12 months. However, as shown in FIG. 3, the dashboard 42 includes a total in this column. The data items 52 further include the number of unique courts that have been attended by the appearance attorney 16 for is the last 12 months. The number of unique courts represents the different number of courts that the appearance attorney has put in an appearance on behalf of the collection law firm 14 or collection law firms 14. Clicking on this data item displays a separate popup window that breaks down the total shown in the dashboard 42 on a monthly basis for the last 12 months.

The bottom of the dashboard 42 shows a data item 52 that is the top five collection firms 14 for the last month that are ranked by number of events for the appearance attorney(s) 16. The collection law firm 14 that has the highest number of events is listed first, followed by the second, third, fourth and fifth. Also included in this data item 52 is a display of the individual overall positive disposition rate for each of the collection law firms 14. As stated, the full dashboard 42 can be displayed on the appearance attorney home page 18, or only select data items 52 shown in FIG. 3 may be displayed on the home page 18.

The machine based system 10 may also be used by the creditor 12, and an administrator of the creditor 12 can be granted access to the system 10 by entering a name and password and be presented with a home page as shown for example in FIG. 2. The home page for the creditor 12 administrator may be the same as that of home page 18 for the appearance attorney 16 with the exception of the top title being different to reflect the fact that it is the home page of the creditor 12. The newsfeed 36 can be the same and thus a repeat of this information is not necessary. However, the dashboard for the creditor 12 administrator may be different than the dashboard 42 of the appearance attorney 16.

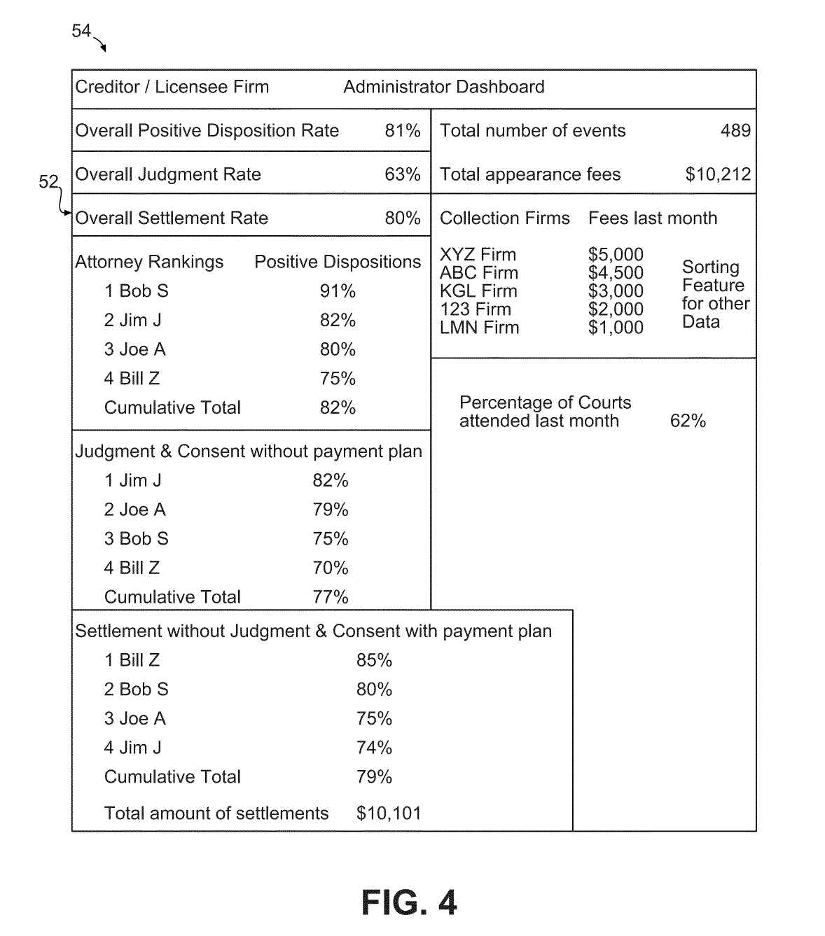

The full dashboard 42 of the creditor 12 administrator is shown with reference to FIG. 4. The creditor dashboard 54 includes a series of data items 52, and the first data item 52 in the upper left hand column is the overall positive disposition rate which is represented as a percentage. The overall positive disposition rate is the percentage of cases with a “positive” disposition that have occurred in the last 12 months. Data item 52 that is below the positive disposition rate is the overall judgment rate which is represented as a percentage. The overall judgment rate is the percentage of cases with a “judgment/award for plaintiff” and a “consent judgment without payment plan” that have occurred in the last 12 months. The overall settlement rate is also included as a data item 52 and is the percentage of cases with a “settlement agreement without judgment/award” and a “consent judgment with payment plan” that have occurred within the last 12 months. Data items 52 of the creditor dashboard 54 also include a list of attorneys in which the attorneys are ranked based on a percentage of positive dispositions that have occurred in the last month. Each appearance attorney 16 is listed and the percentage of positive disposition for that particular appearance attorney 16 is included next to his or her name. The appearance attorney 16 with the best or highest positive disposition percentage is listed first and the appearance attorneys 16 are ranked in subsequent order. A cumulative total is included at the bottom of this data item 52 and is the average of the percentages listed in the positive dispositions.

The creditor dashboard 54 also includes a data item 52 that is a list of the appearance attorneys 16 that are based on the percentage of judgments received in the last month for a “judgment/award for plaintiff” and a “consent judgment without payment plan.” The appearance attorneys 16 are listed in descending order from the highest percentage to the lowest percentage for the “judgment/award for plaintiff” and is the “consent judgment without payment plan.” A cumulative total that is the average of all of the percentages listed is displayed for the creditor 12 administrator to view. The data items 52 also include a list of attorneys that is based on the percentage of settlements received in the last 12 months. The list of settlements include the “settlement agreement without judgment/award” and the “consent judgment with payment plan” that have occurred for each attorney in the last 12 months. The attorneys are listed in descending order from highest percentage to lowest percentage. The data item 52 also displays the cumulative total for the creditor 12 administrator which is the average percentage of all of the percentages listed for the appearance attorneys 16. This data item 52 also displays the total amount of settlements and in the exemplary embodiment of FIG. 4 as shown is $10,101. The total amount of settlements is the total settlement amount and not monthly payment amounts.

The data items 52 of the creditor dashboard 54 also include in the upper right hand column the total number of events on a monthly basis for the last 12 months. The dashboard 54 displays the total number of events that have occurred in the last 12 months. Clicking on this data item 52 causes a popup window to be displayed in which the number of events per month for the last 12 months are presented to the creditor 12 administrator. The data items 52 also include the total appearance fee which is the cumulative sum of appearance fees that have been charged to the creditor 12 administrator in the last 12 months. Clicking on this data item 52 provides the creditor 12 administrator with a popup window that displays a monthly breakdown of the total appearance fees.

Creditor dashboard 54 also includes a list of collection firms 14 that are ranked by total fees that had been generated in the last month. The collection law firm 14 with the highest number of fees generated in the last month is listed first and the second highest generating firm is listed below that firm. The collection law firms 14 are listed in subsequent descending order. A sorting feature next to this list is presented to the creditor 12 administrator and if selected by the creditor 12 administrator displays a popup window that has additional data. This additional data will be a display of the number of events, the average fees per event, the maximum fee paid, the number of unique courts, the positive outcome percentage, the total judgments received, and the total settlements received that have occurred all in the last month. These various data fields are sortable by the creditor 12 administrator so that the collection law firms 14 can be ranked based on any of the aforementioned items.

The fees that are charged by an appearance attorney 16 may be thought of as compensation to the appearance attorney 16 for completing an event. The fees for each of the events may be initially populated by the system 10 as default compensation data that can be stored by the system 10 for each event and/or each appearance attorney 16. The initial compensation data may be input based upon the appearance attorney's 16 agreement with the collection law firm 14. This compensation data may be editable by the system administrator, collection law firm 14, or appearance law firm 15. The system 10 can track the amount of compensation paid to the appearance attorneys 16 and the amount of fees charged to the creditor 12 for the used of the machine based system 10 and work done by the appearance attorneys 16 and the system 10 may report to the collection law firm 14 or appearance law firm 15 the amounts paid by the creditors 12 and the amounts paid to the appearance attorneys 16. This data may be reported as a total quantity, or may be reported as per event.

The creditor dashboard 54 also includes data item 52 in the bottom right hand corner that is a percentage of courts that have been attended in the last month. This percentage of courts is the percentage of unique courts out of the total number of courts that have been assigned to the creditor 12 administrator.

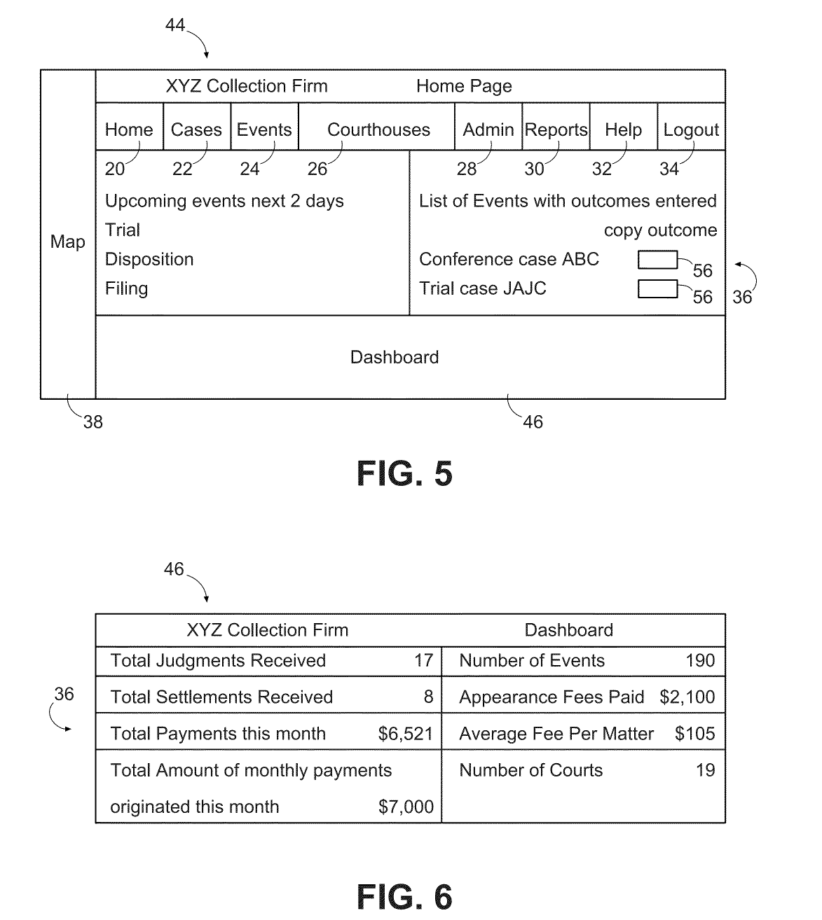

The machine based system 10 may also be used by the collection law firm 14. After entry of an appropriate user name and password, a user of the collection law firm 14 may be presented with a home page 44 of the collection law firm as shown in FIG. 5. The home page 44 of the collection law firm may again include tabs 20, 22, 24, 26, 28, 30, 32 and 34 as previously discussed and a repeat of this information is not necessary. A newsfeed 36 and dashboard 46 for the collection law firm are also included on the home page 44. The tabs, newsfeed 36 and dashboard 46 may be placed on the right hand side of a map 38. Map 38 shows the location of various courthouses and other jurisdictions that are assigned to the collection law firm 14. The map 38 may make up ⅓ of the width of the home page 44, ½ of the width of the home page 44, or may make up ⅔ of the width of the home page 44 in accordance with various exemplary embodiments.

The newsfeed 36 may include a list of upcoming events for the next two days. This list may include events such as trials, depositions and filings. Clicking on the individual event in the list of upcoming events may cause a popup window to be displayed that includes more detailed information about that particular event. Also included in the newsfeed 36 is a list of events with outcomes that have been entered. Up to 20 records may be displayed in this list, although as shown in FIG. 5 only two such events are displayed. The events may be sorted in order of most recent to most distant such that the most recent event is included at the top and first. Each event in the list of events with outcomes entered may include an event caption and an event case number. Copy outcome buttons 56 may be located next to each of the records. The collection law firm 14 user may click on the copy outcome button 56 that is located next to a particular event so that the record of the event is copied to a clipboard such that all of the outcome information in a text file may be downloaded to a database of the collection law firm 14. Once the information from the completed event is downloaded or otherwise saved, the copy outcome button 56 may be replaced with a checkmark to indicate that the event information has been successfully downloaded. Additionally, or alternatively, the event can be removed from the list of events with outcomes entered once the collection law firm 14 user has downloaded the information.

The newsfeed 36 of the home page 44 for the collection law firm 14 may be capable of being filtered by users of the collection law firm 14. In this regard, firm administrators may see all the activity that is included within the newsfeed 36, while non-administrators of the collection law firm 14 may only see activity for cases that are specifically assigned to their account. The newsfeed 36 may also include a dashboard 46 which is a dashboard 46 of the collection law firm 14. Dashboard 46 is shown in greater detail in FIG. 6. FIG. 6 shows the full dashboard 46 of the collection law firm 14. The dashboard 46 may be displayed only for firm administrators of the collection law firm 14, while dashboard information is not displayed if the user of the collection law firm 14 is a non-administrator. As with previously discussed exemplary embodiments, all of the data items 52 of the dashboard 46 may be displayed on the home page 44, or only select portions of the data items 52 may be displayed on dashboard 46 of the home page 44.

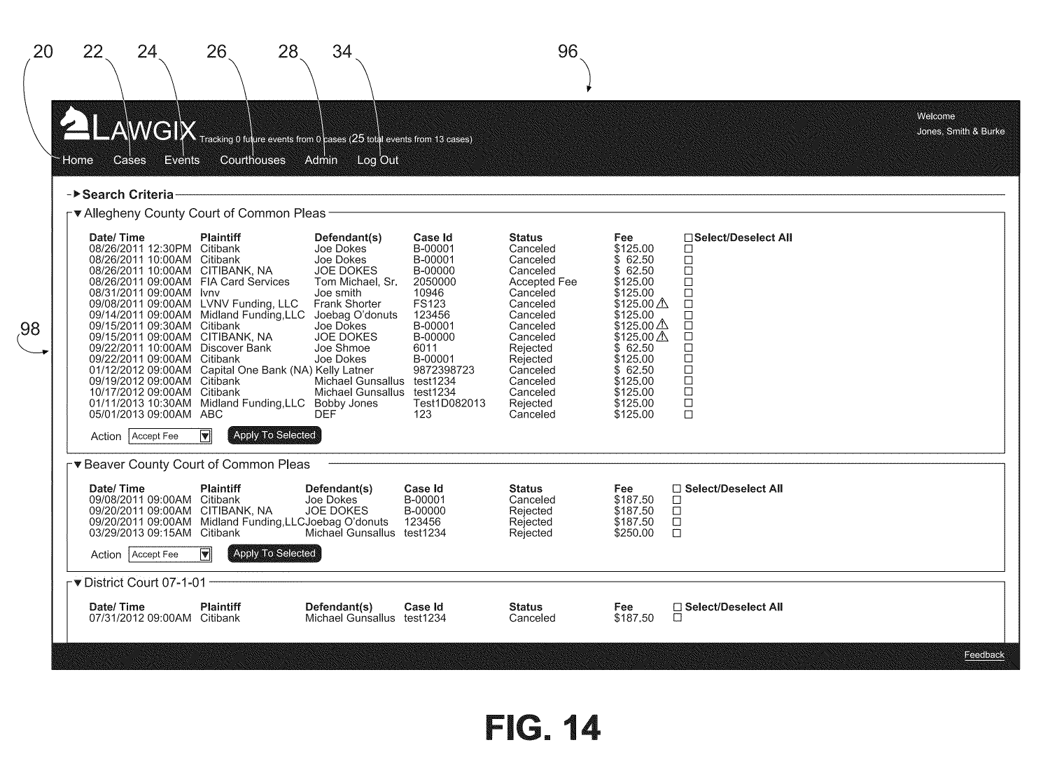

The data items 52 of the dashboard 46 can be filtered depending upon whether the user of the collection law firm 14 is a firm administrator or a non-administrator. As such, various data items 52 are displayed based upon the status of the particular user of the collection law firm 14. In the exemplary embodiment illustrated in FIG. 14, all of the data items 52 are displayed and the user of the collection law firm 14 is an administrator. The data items 52 include a total dollar amount of judgments received which is a number of the “judgment/award for plaintiff” and the “consent judgment without payment plan” that have occurred for the collection law firm in the last 12 months. Clicking on this data item 52 may cause a popup window to be displayed that shows a monthly breakdown of the total judgments received per month for the last 12 months.

Data item 52 of the dashboard 46 also includes total settlements received for the last 12 months. The total settlements received is the total number of the “settlement agreement without judgment/award” and “consent judgment with payment” for the collection law firm 14 for the last 12 months. Clicking on this data item may cause a popup window to be displayed that breaks down the total settlements received per month in monthly format.

Also included in the data items 52 of the dashboard 46 is a total payments which is the total amount in lump sum payments that have occurred for the collection law firm in the last month. Data items 52 also include the total amount of monthly payments that had been originated in the particular month. This number, along with the total payments number, are represented in dollar amounts. The right hand side of the dashboard 46 at the top includes data item 52 that is the number of events that have occurred in the last 12 months. The number of events is the cumulative total of the number of events that have occurred in the last 12 months. Clicking on this data item 52 causes a popup window to be displayed that breaks down the number of events per month for the last 12 months. The collection law firm 14 may use this data item 52 for internal rewards programs such that appearance attorneys 16 can be rewarded if they have events that are over 75 in total, over 100 in total, or over 150 in total. The internal rewards programs may not be present in other exemplary embodiments of the machine based system 10.

The dashboard 46 also includes a data item 52 that is the appearance fees that have been paid for the last 12 months. This total is expressed in a dollar amount is the total amount of appearance fees that have been paid by the collection law firm 14 in the last 12 months. Clicking on this data item 52 causes a popup window to be displayed that breaks down the appearance fees paid in the last 12 months into monthly totals. Also included is data item 52 that is the average fees paid per matter for the last 12 months. This average fee is expressed in a dollar amount. Clicking on this data item 52 causes a popup window to be displayed that shows the average fees paid for each month of the last 12 months.

Another data item 52 that is displayed on the dashboard 46 of the collection law firm 14 is the total number of unique courts. The total number of unique courts is the total number of courts in the last 12 months that have been utilized in the collection is process of the collection law firm 14 such that appearance attorneys 16 have appeared in the those particular courts. Clicking on this data item 52 will again cause a popup window to be displayed that breaks down the number of unique courts per month that have occurred in the last 12 months. Although all of the data items 52 can be displayed in the dashboard 46 in accordance with various exemplary embodiments only a portion of the data items 52 can be included in the dashboard 46 as displayed on the home page 44 of the collection law firm 14.

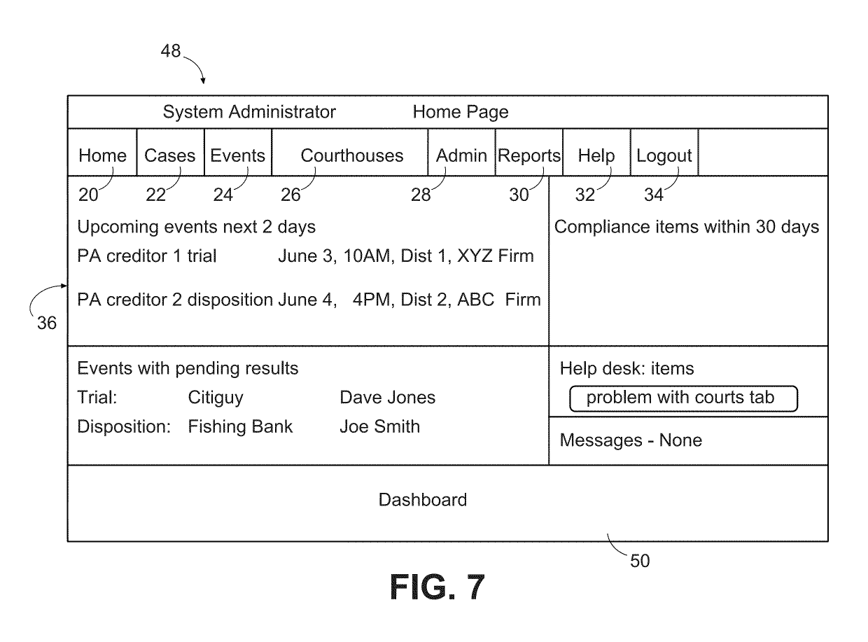

Referring now to FIG. 7, a system administrator home page 48 is shown that is presented to a system administrator upon entry of an appropriate user name and password. The system administrator may be an administrator of the machine based system 10 and need not be the creditor 12, collection law firm 14 or appearance attorney 16. The system administrator may be someone that has the capability of monitoring the machine based system 10 to ensure that it works properly for the various parties involved. The system administrator home page 48 includes the various tabs 20, 22, 24, 26, 28, 30, 32 and 34 as previously discussed and a repeat of this information is not necessary. A newsfeed 36 is also included and may list upcoming events for the next two days. The upcoming events are identified via state in which they are to take place. Each event may also be identified by the particular entity to which the event is directed. The entity may be the particular creditor 12 associated with that event. The event may also include a caption, for example whether the event is a trial or a deposition, along with the date and time of the event, the court in which the event takes place, and the collection law firm 14 that will handle the particular event. The upcoming events may be listed in descending order from the event most immediate to the event leased immediate in descending order.

Also included in the newsfeed 36 is a list of events with pending results. This list may include all events with pending results that are more than 48 hours delinquent. The pending results may be listed by days delinquent from oldest to newest starting with the oldest on top. Each pending result may include a caption that identifies the result, such as a trial or deposition, and may each include the creditor 12 to which the result pertains along with the appearance attorney 16 that is responsible for the result. Clicking on one of the events may cause a popup window to appear that includes the event record for the particular pending result.

The newsfeed 36 of the system administrator home page 48 also includes in an upper right hand corner a list of compliance items that are within 30 days of expiration. The compliance items may be, for example, malpractice insurance renewals that are due for a particular collection law firm 14 or appearance attorney 16, a renewal of contract for one or more of the collection law firms 14, appearance attorney 16, or creditor 12, or other compliance item. The newsfeed 36 may also include a list of help desk action items that are 48 hours past due. The help desk items may be problems that a user of the machine based system 10 such as a creditor 12, collection law firm 14, or appearance attorney 16 submits via the help tab 32. The system administrator may review the problem submitted via the help tab 32 in the newsfeed 36 and take appropriate action. Also included in the newsfeed 36 is a message section that lists any messages that may be sent to the system administrator. A dashboard 50 of the system administrator is likewise included in the newsfeed 36.

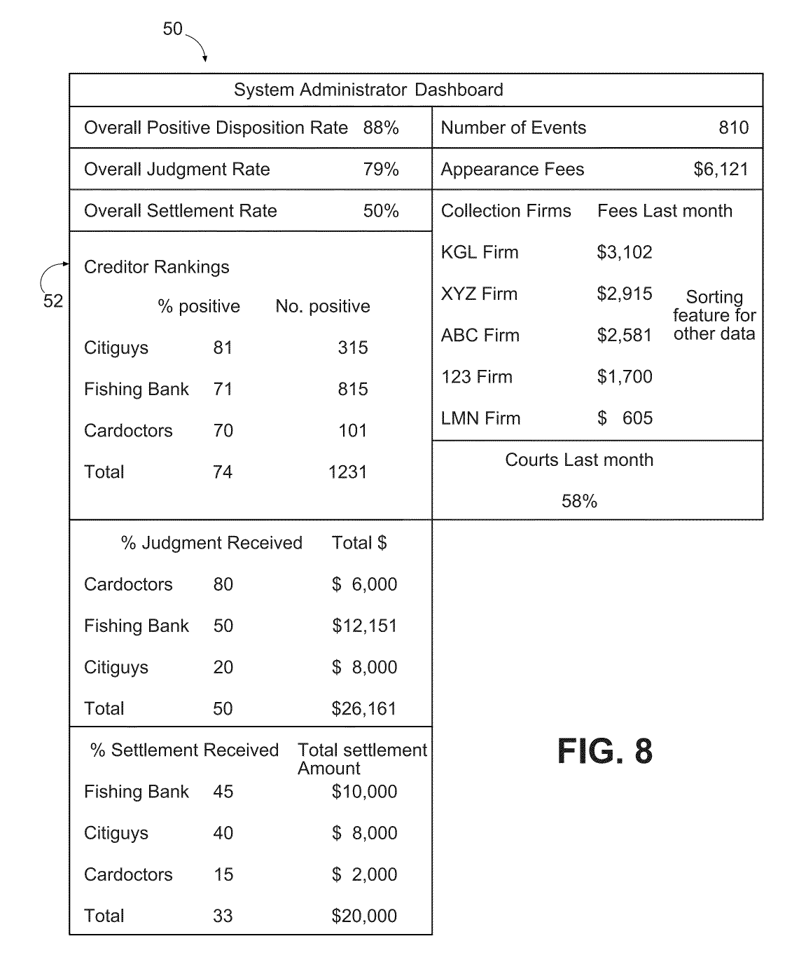

The dashboard 50 is shown in greater detail in FIG. 8 for clarity. The system administrator dashboard 50 as illustrated in FIG. 8 may include data items 52 that are all displayed in the system administrator home page 48. Alternatively, only some of the data items 52 of the system administrator dashboard 50 are shown in the system administrator home page 48. Clicking on the reports tab 30 may cause the entire system administrator dashboard 50 to be displayed in certain exemplary embodiments. The data items 52 include in the upper left hand corner the overall positive disposition rate which is the percentage of cases in the machine based system 10 that have a “positive” disposition in the last 12 months. Also included in the data items 52 is the overall judgment rate which is the percentage rate in the last 12 months that are described as a “judgment/award for plaintiff” and a “consent judgment without payment plan.” Also included is an overall settlement rate which is the percentage of cases in the last 12 months that are described as being a “settlement agreement without judgment/award” and a “consent judgment with payment plan.”

The data items 52 of the dashboard 50 further includes creditor rankings that are based on the percentage of positive dispositions in the last month. The creditor 12 that has the highest positive disposition percentage in the last month is ranked first and subsequent creditors 12 are listed below in descending order. Also displayed in the data item 52 are the number of positive dispositions for each creditor 12 and the cumulative total for the entire machine based system 10.

The data items 52 further include a creditor 12 ranking that is based on the percentage of judgments received in the last month. This item is calculated by observing the number of “judgment/award for plaintiff” and the “consent judgment without payment plan” that occur in the last month for each creditor 12. The creditor 12 with the highest percentage is listed first and subsequent creditors 12 are listed in descending order. Also displayed is the total dollar amount of the judgments for each creditor 12 and also the cumulative total for the machine based system 10. The cumulative total averages the percentage included and also lists the cumulative total of the dollar amounts.

Also included in the data items 52 in the lower left hand corner of the system administrator dashboard 50 is a list of all creditors 12 that is based on the percentage of settlements received in the last month. This ranking is calculated by adding the number of “settlement agreement without judgment/award” and the “consent judgment with payment plan” that have occurred for each of the creditors 12 in the last month. The rankings are in descending order highest to lowest. Also included with each creditor is a display of the total amount of settlements. This amount is in dollars and is based on the total settlement amount and not the monthly payment amounts. Cumulative totals for the percentages and dollar amounts are included. The cumulative total of the percentage is the average percentage and the cumulative total of the settlement amount is the addition of all of the settlement amounts for each of the creditors 12.

The data items 52 further include in the upper right hand corner the total number of events that have occurred in the machine based system 10 in the last 12 months. Clicking on this data item 52 may cause a popup window to be displayed that breaks down the total number of events into a monthly basis for the last 12 months. Also included is a data item 52 that displays the total amount of appearance fees that have been accumulated in the machine based system 10 in the last 12 months. Clicking on this data item 52 may again cause a popup window to be displayed that breaks down the dollar amounts of appearance fees per month.

Also included in the data items 52 is a list of all collection law firms 14 that are ranked by total fees in the last month. The collection law firm 14 that has the highest amount of fees in the last month is listed first, and subsequent law firms and their fee amounts are listed below in descending order. A sorting feature for other data is also included and if clicked on by the system administrator allows for the display of various rankings of the various collection law firms 14 in a popup window. The collection law firms 14 may be ranked as selected by clicking on the sorting feature for other data via their number of events, average fees per event, maximum fee paid, number of unique courts for each of the collection law firms 14, the positive outcome percentage, the total judgments received, and the total settlements received. All of these rankings for the collection law firms 14 are for the last month. Each one of these data fields can be selected by the system administrator so that the listing of collection firms is made in descending order from highest to lowest for that particular data item selected. For example, if clicked on via positive outcomes, the collection law firms 14 shown in the popup window will be listed from highest to lowest such that the highest collection law firm 14 has the highest positive outcome. The dashboard 50 can be arranged so that the data item 52 that is displayed on the system administrator dashboard 50 is the field that is selected by the sorting feature for other data by the system administrator. For example, if the positive outcomes data field were selected in FIG. 8 after the popup window is closed, the collection firm listing will not be via fees collected in the last month but will instead be displayed as the list of collection firms 14 via their positive outcomes.

The dashboard 50 for the system administrator further includes in the lower right hand corner a data item 52 that is the percentage of courts attended in the last month. This percentage is the percentages of unique courts out of the total number of courts that are assigned in the machine based system 10. For example, if there are 100 unique courts that are listed in the machine based system 10, and if 58 of those courts have been attended by various appearance attorneys 16 in the last month, the percentage displayed will be 58%.

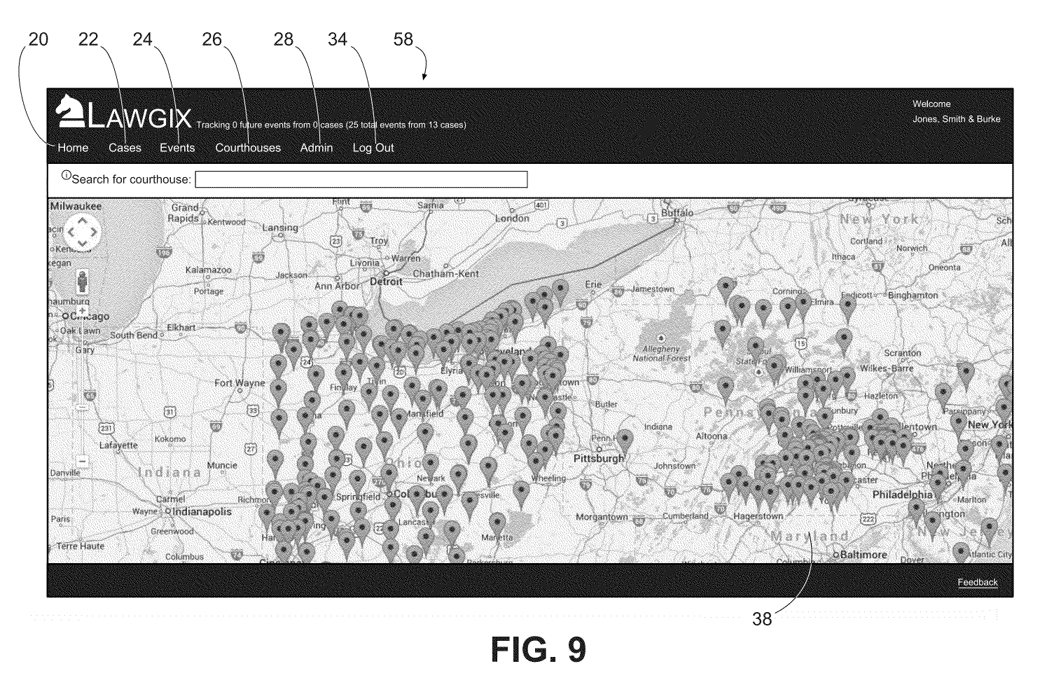

With reference now to FIG. 9, a home page 58 is shown that is presented to a user of the machine based system 10 after entering an appropriate user name and password. The home page 58 includes home tab 20, case tab 22, events tab 24, courthouse tab 26, administration tab 28, and logout tab 34. A newsfeed 36 is not included in the home page 58 shown in FIG. 9. Instead, a map 38 is shown that displays the location of the various courthouses that are assigned to either the user of the machine based system 10 or to all of the various users of the machine based system 10. The user may click on a particular location on the map 38 in order to get information on the courthouse selected such as directions, the address, hours of operations, or other information associated therewith. The map 38 may not be present on the other home pages as previously discussed. In this regard, the map 38 may be accessible by the user by clicking on the courthouse tab 26. Doing so will allow the user the option of viewing the map 38 and, if selected, will be displayed as shown for example in FIG. 9.

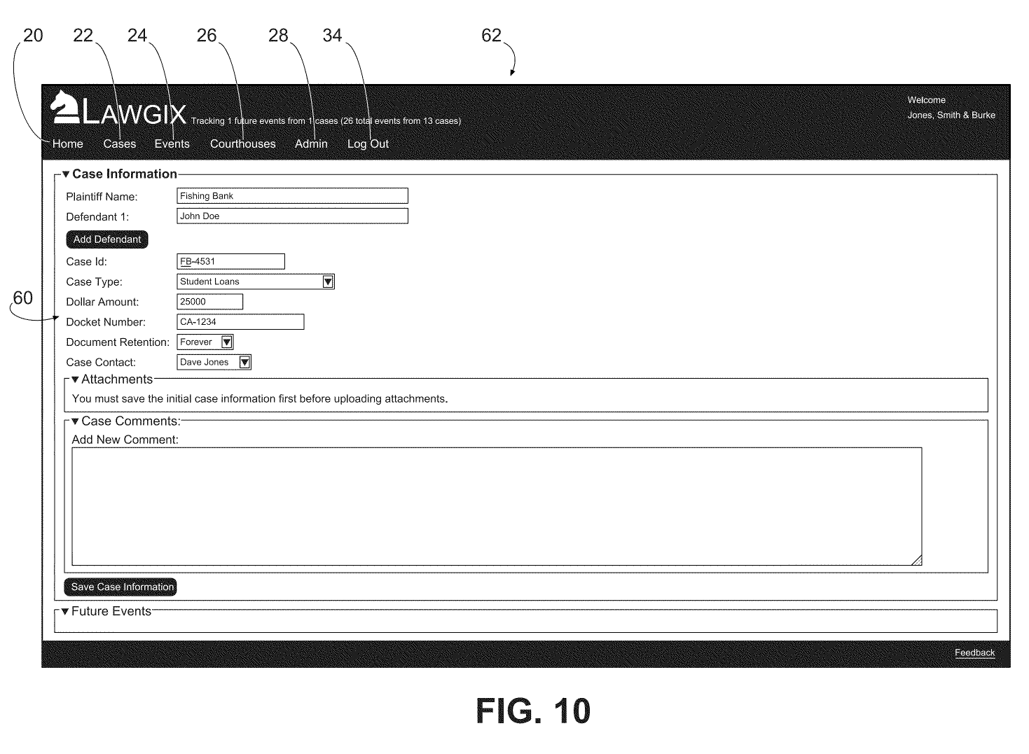

Clicking on the case tab 22 will cause a screen to be displayed that allows the user of the system to search for a particular case or cases. A case I.D. field will be presented in which the user may enter in the name of the case in order to access information regarding same. Alternatively, an advanced search criteria box may be presented to the user that includes a search field entitled “plaintiff” and a search field entitled “defendant” into which parties' names may be entered. Clicking on a search button of the screen will then allow the user to pull up all cases that feature that particular plaintiff or that particular defendant. The case tab 22 also includes a selection item that allows for the submission of a new case. With reference now to FIG. 10, a screen that is displayed after a “submit new case” item of the case tab 22 is displayed. The new case screen 62 includes a series of new case screen fields 60 that can be completed by the user in order to input information relevant to a new case. The new case screen fields 60 include the plaintiff's name, and the defendant's name. An add defendant button is included that avows for multiple defendants to be added. Also included in the new case screen field 60 is a case I.D. number, and a case type. The case type may be, for example, consumer credit original grantor, consumer credit debt buyer, auto deficiency, insurance subrogation, commercial collections, or student loans. The new case screen field 60 also includes a dollar amount and docket number that can be entered by the user. A document retention entry field is also included in the new case screen fields 60 and a dropdown arrow may be actuated by the user in order to select an appropriate amount of time for document retention. The document retention may be, for example, forever, 1 day, 3 days, 7 days, 30 days, 60 days, 90 days, 180 days, or 365 days. The new case screen field 60 also includes a case contact that may be the appearance law firm's 15 internal user. A list of appearance attorneys 16 included in the machine based system 10 can be selected by actuation of a dropdown arrow.

The new case screen fields 60 also includes an attachment section in which documents such as credit card statements, or loan documents may be uploaded into the system to be viewed at future times. A case comments field is also included in the new case screen fields 60 and allows the user the opportunity to add comments regarding the case. A screen for future events is further included in the new case screen fields 60 in which events relevant to the case being added can be entered. The new case screen fields 60 may include a button in order to save the case information. Once saved, the new case may be viewed by all or select users of the machine based system 10.

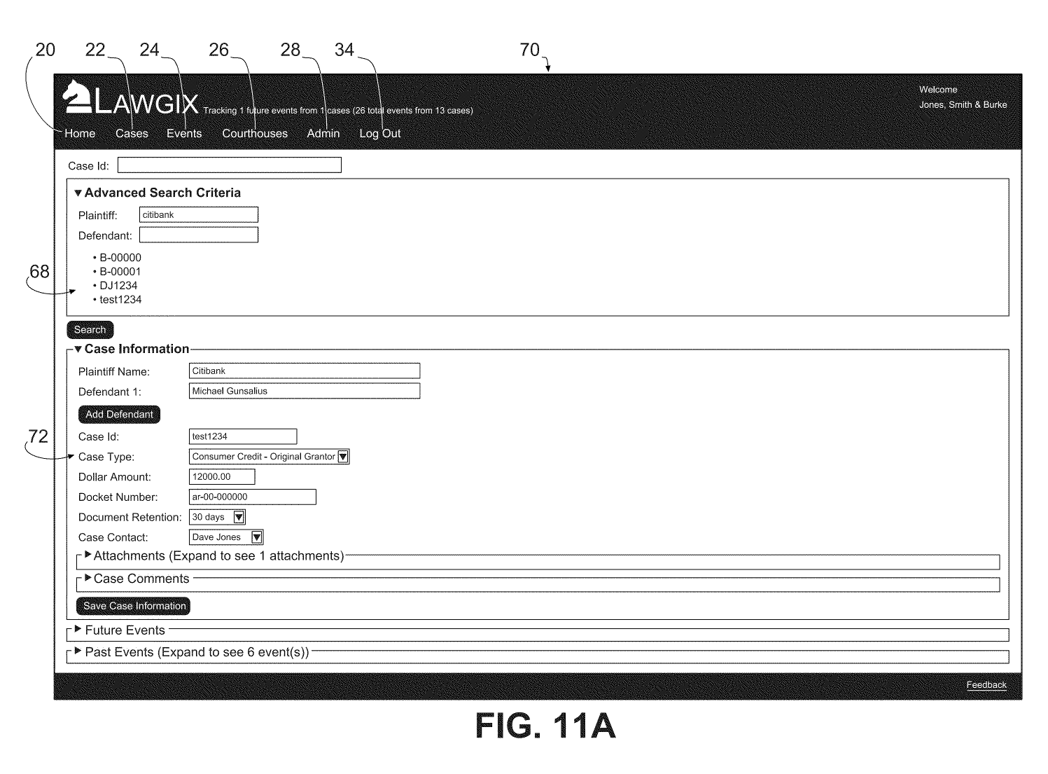

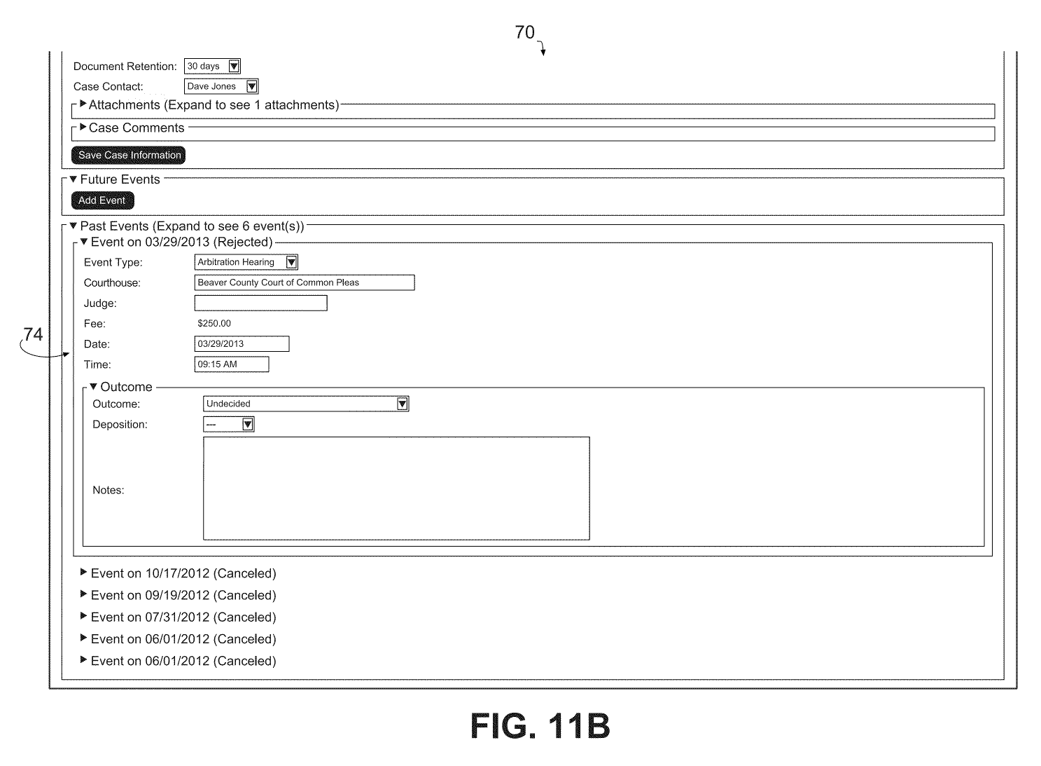

With reference now to FIG. 11a, a screen is shown that is displayed after the user selects the case tab 22 and clicks on the find case section and enters a plaintiff name into the advanced search criteria and hits the search button. The screen that is displayed upon clicking the “find case” button is the find case screen 70 as shown in FIG. 11a. Entry of a plaintiff name brings up four cases returned 68 in which the plaintiff that is entered is a plaintiff in all four of the cases. The user will then select one of the four cases so that the case information from that case can be viewed. In the example shown, the user has selected the “test 1234” case and doing so causes the case information 72 for the test 1234 case I.D. to be displayed.

The case information 72 that is displayed is the plaintiff's name, the defendant's name, the case I.D., the type of case, the dollar amount in question, the docket number of the case, the document retention instructions for this particular case, and the case contact that can be the appearance attorney 16 in charge of the particular case, the administrator of the appearance law firm 15, or another user of the appearance law firm 15. The case information 72 may also include attachments and, as shown, one attachment is present. If the user clicks on the attachments button in the case information 72 section, a pdf file will open up that is various credit card statements of the defendant. The case comment section is also included and if any comments on this particular case that would be entered by the creditor 12, collection law firm 14, or appearance attorney 16 were made, they would appear in this section. This information can be updated by the appearance attorney 16 or other user using the machine based system 10 and saved by clicking on the saved case information button. Also shown in the find case screen 70 is a future events section. Although no future events are present in the example in FIG. 11a, any future events that relate to this particular case would be shown in this section.

With reference now to the bottom of FIG. 11a and to FIG. 11b which is an extension of the find case screen 70, a past events section of the find case screen 70 is shown. Clicking on the past events tab, the section will be expanded so that all six past events are shown. The user may then click on one of the six past events in order to access detailed information about that particular past event. In the example shown, the user has selected the event on Mar. 29, 2013. Doing so brings up the various event information 74. The event information 74 shows the type of event. The type of event in the present case is an arbitration hearing. Other event information 74 that may be displayed includes the courthouse in which the event will take place, the judge that will preside over the particular event, the fee that is paid to the appearance attorney 16 for taking part in the particular event, the date of the event, and the time of the event. Additional event information 74 is the outcome of the event. In the particular example shown, the outcome is an undecided outcome. Other information that may be displayed or entered includes the disposition and notes that may be entered on that particular event's outcome. Additional information that may be included in the event information 74 includes the appearance attorney 16 that is assigned along with the telephone number of the assigned appearance attorney 16.

The machine based system 10 may include an alarm component 234 that may be used to alert a user of information relating to an event. The alarm component 234 may send an alarm to a user of the system when event information is changed. In some arrangements, the alarm component 234 only sends an alarm when the change to the event takes place at a point in time under 36 hours before commencement of the event. The alarm component 234 may send an alarm to a user of the system 10 to alert the user that the event will occur at some future point in time. For example, the alarm may be sent when the event is 15 minutes, 30 minutes, or one hour from taking place. The alarm that is sent by the alarm component 234 may be an audible alarm that the user hears when the alarm is sent. The alarm may be a text message that is sent to a mobile device of the user when the alarm component 234 actuated. The alarm component 234 may also cause an alarm to be generated that is an email message that is sent to the user of the system 10.

The creditor 12 may pay the owner/licensee of the system 10 to perform a certain legal task such as the collection of a debt. The system 10 may collect the fee before events are assigned to appearance attorneys 16. The system 10 may ask the appearance attorney 16 whether he or she wants to accept the event. If the appearance attorney 16 does not accept the event then a second appearance attorney 16 will be asked until the event is assigned to an appearance attorney 16. Once the appearance attorney accepts the event then the system 10 automatically updates the status of the event to “accepted” and informs the creditor 12 that the event was accepted.

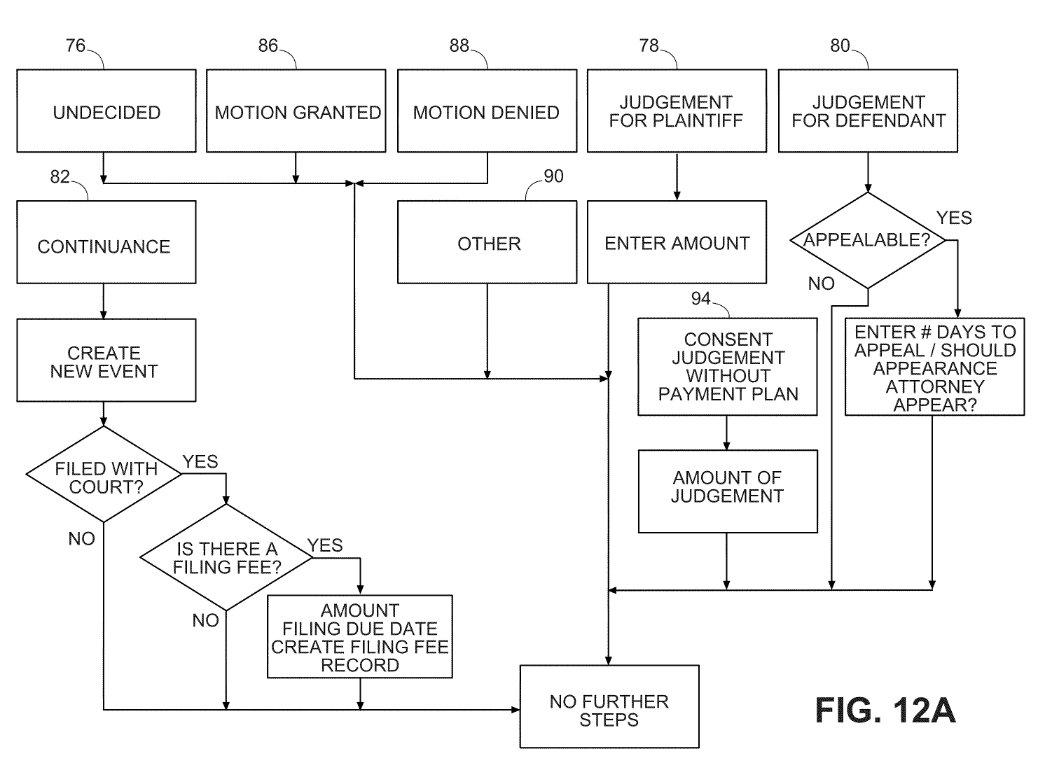

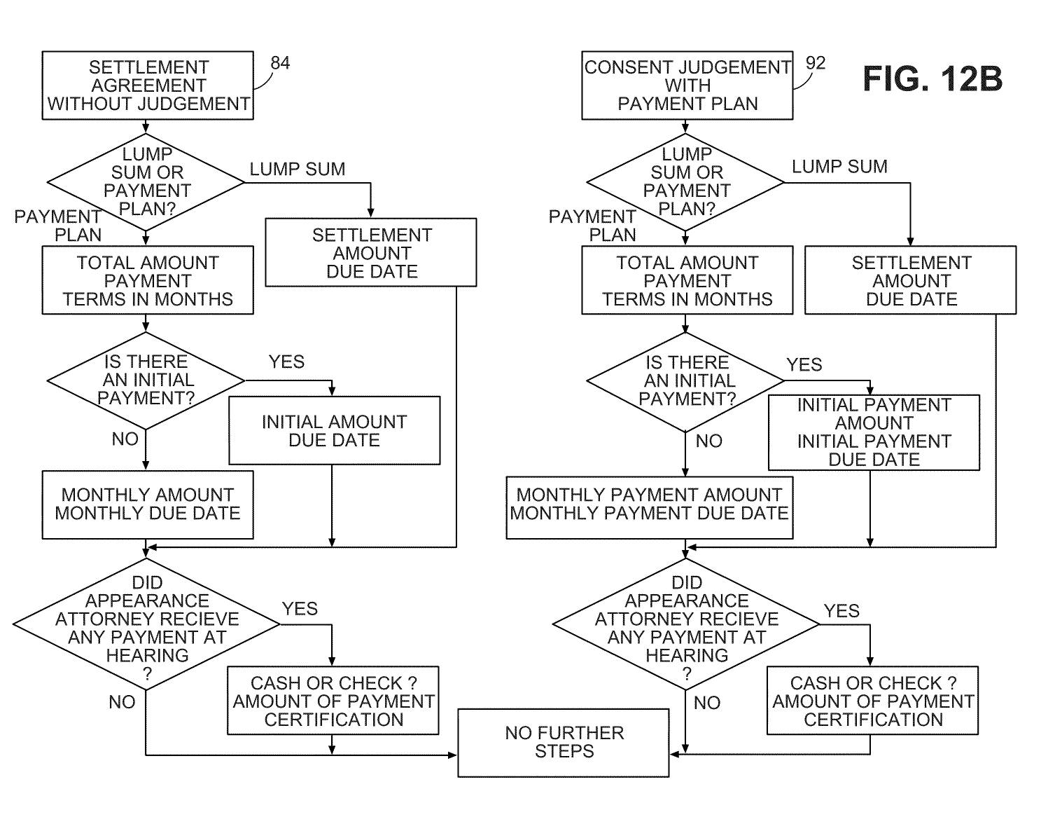

The outcome of events can be entered by the appearance attorney 16 or by any other user of the machine based system 10 once the outcome of the particular event is known. FIGS. 12a and 12b disclose various outcomes of events that may be entered into the machine based system 10. This entry may take place in the outcome section of the events in the event information 74 section of the find case screen 70. Alternatively, other areas of the machine based system 10, for example in the events tab 24, can be used in order to input the appropriate outcome of the events. If the outcome of the event is undecided 76, the user will be required to take no further steps and the event can be appropriately updated. Likewise, if the outcome of the event is a motion that is granted 86, a motion that is denied 88, or other 90 outcome then no further steps are taken and the event is appropriately updated. However, in certain exemplary embodiments event comments may be entered by the user at this point in the process.

If the outcome of the event is a judgment or award for the plaintiff 78, a field will appear that will require the user to enter the amount of the judgment. After doing so, there will be no further steps taken and the outcome of the event will be appropriately updated and saved. If the outcome of the particular event is a consent judgment/award without a payment plan 94 then a field will be presented to the user to enter the amount of the judgment. After doing so, the outcome will be appropriately updated and saved and there will be no further steps taken. Another possible outcome for an event may be a judgment/award for the defendant 80. If this outcome is entered, a selection box will be presented to the user that will ask whether the particular judgment/award for the defendant is appealable in the particular case. If the judgment/award is in fact appealable, then the user will be requested to enter additional information. The additional information that will be entered will be the number of days available for taking an appeal, and a decision will be made by the appearance attorney 16 whether he or she recommends appearing at a future hearing. After doing so, no further steps are taken. Likewise, if the judgment/award for the defendant is not appealable, then no further steps are taken. The outcome is appropriately entered and the event is updated.

Another possible outcome of an event is a continuance 82 that may be granted. If this is the case, a new event will be created and certain case/event information from the prior event from which a continuance was taken will be pre-populated. The user may be prompted to enter a new date and time for the event that was continued. The submitted status will remain the same pending acceptance of the fee by the collection law firm 14. The system will then ask the user whether the continuance needs to be filed with the court. If the continuance does need to be filed with the court, the system will then ask the user whether there is a filing fee. If a filing fee is required, then the user will be prompted to enter the amount of money that the filing fee will cost, and will be prompted to enter when the filing of the continuance must be filed. This will be a date that may be entered by the user. Also, the system will create a “filing fee” record for payment. Afterwards, no further steps will be taken. If there was not a filing fee to be paid for filing the continuance or if the continuance did not need to be filed with the court there will be no further steps to be taken. Once no further steps are necessary, the outcome will be appropriately entered and the event will be updated.

With reference now to FIG. 12b two additional outcomes are illustrated that may be entered by the user for a particular event. The two outcomes shown in FIG. 12b are a settlement agreement without judgment/award 84 and a consent judgment/award with payment plan 92. The series of questions and data entries prompted by the system upon the selection of either of these outcomes 84 or 92 are the same and thus a repeat of this information is not necessary. Upon the selection of either outcome 84 or 92, the machine based system 10 will prompt the user with a question as to whether the judgment/award was a “lump sum” or a “payment plan”. Selection of a radio button for each particular option may be presented to the user. If “lump sum” is selected, the user will then be requested to enter the settlement amount in dollars. Also, the user will be prompted to enter the due date and, in this regard, a specific calendar date can be selected.

The system will then move to the question as to whether an appearance attorney received payment at the hearing. If the judgment/award is a “payment plan”, then the user will be prompted to enter the total settlement amount in dollars and the payment term in months. The user will then be asked whether an initial payment is to be made. If an initial payment is in fact to be made, then the user will be asked to enter the initial payment amount and the initial payment due date which could be a specific calendar date. If there is not an initial payment, then the monthly payment amount will be requested to be entered and the monthly payment due date will be likewise entered by the user. The monthly payment due date will be the date of the month upon which the monthly payment is due. The entries for the outcome will then move to the decision box that asks whether an appearance attorney received any payment at the hearing.

If the appearance attorney 16 did not receive any payment at the hearing, then no further steps are taken. If the appearance attorney did in fact receive a payment at the hearing, then the user will be asked whether the payment was in cash or a check. A radio button may be presented to the user so that he or she may input whether a check or cash were transferred. Also, the amount of the payment in dollars will be entered by the user at this point. The user will also be presented with a checkbox. Selection of the checkbox functions to make a certification. The certification is that the “attorney certifies that all funds were remitted” on the particular date. A popup calendar may be provided to allow for the date as to when this certification of funds was received. If this box is left unchecked by the user for five days, then an email will be sent to the appearance attorney 16, the creditor 12, and the system administrator informing them of the fact that the certification has not been made. Once these steps are completed, no further steps are due for this particular outcome and the event is appropriately updated.

The aforementioned dynamic outcomes 76, 78, 80, 82, 84, 86, 88, 90, 92 and 94 may be entered by the appearance attorney 16 in certain exemplary embodiments. However, other users of the machine based system 10 may enter these outcomes. As stated, these outcomes may be entered in the event information 74 section of the find case screen 70. However, the various outcomes may also be entered through the events tab 24 or through module 5 of a mobile application as will be momentarily discussed. Capability to enter the outcomes may be provided either in the mobile application, or in a web based application at a desktop or other location of a user.

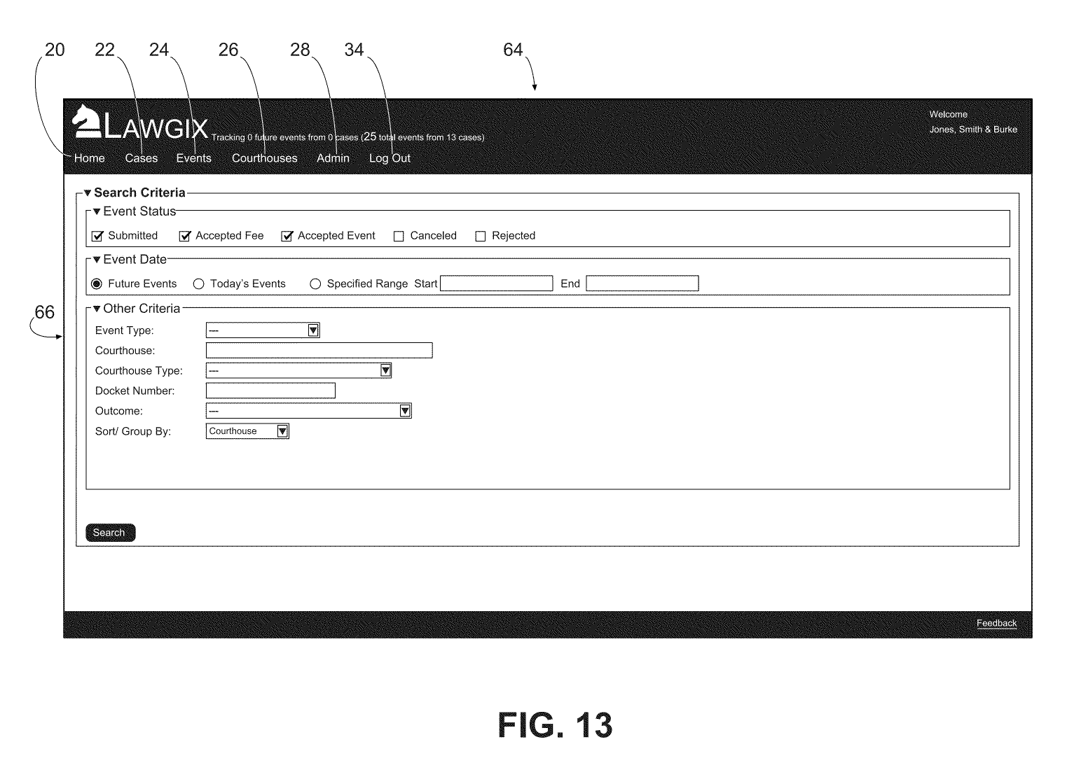

The various events of the machine based system 10 can be accessed, searched and modified in a number of ways. A user may click on the events tab 24 so as to be presented with a dropdown box that includes selection criteria such as “find events”, “submit new event”, and “print attorney appearance package.” Selection of the “find events” item in the events tab 24 will cause the find events screen 64 in FIG. 13 to be presented to the user. The find events screen 64 may have tabs for selection such as the home tab 20, case tab 22, events tab 24, courthouse tab 26, administration tab 28 and logout tab 34. The find events screen 64 also includes a series of event search fields 66 that can be filled in or selected by the user in order to search in a variety of manners for one or more events. The event search fields 66 allow for the searching of events by their status. For example, the user may search for events that have been submitted, accepted fee, accepted event, canceled, and/or rejected. Also included in the event search fields 66 is a search via the event date. Events may be searched through the selection of a radio button to look for either future events, today's events, or a specified range. If selecting the specified range, the user may enter a start date and an end date. This selection field 66 may be either manually input by the user or selected via a popup calendar.

The event search fields 66 also include a section entitled “other criteria” that allows for further searching of particular events. One may enter an event type that may be, for example, an oral argument, an arbitration hearing, a trial, a conference, a magistrate hearing, a deposition, other, filing, or scheduling. The event search fields 66 also include a courthouse section where the user may select a particular courthouse for searching of events. All of the courthouses entered into the system 10 may be accessible at this point through clicking a box next to the event field. Alternatively, one may simply type in the name of the courthouse in the event search fields 66.

Another searchable field is a courthouse type. This may be, for example, the court of common pleas, magisterial district justice, a court of common pleas arbitration division, a municipal court, town courts, or county courts depending upon the particular state system. Additional event search fields 66 on the find event screen 64 include a docket number, outcome (which may be any of the outcomes previous discussed with respect to FIGS. 12a and 12b), and a sortable feature that allows for the sorting of the to be received results via either the courthouse, the date, or the outcome. Selection of the various event search fields 66 in the find event screen 64 causes search results to be retrieved in which the selected event search fields 66 function to further limit the return researches and thus function in an “and” manner. Clicking on a search button will cause search results to be retrieved as per the criteria selected on the find event screen 64.

FIG. 14 illustrates an exemplary embodiment of an event results screen 96 that may be retrieved after entering an appropriate search criteria on the find event screen 64 previously discussed. The event results screen 96 includes a series of tabs 20, 22, 24, 26, 28 and 34 along with the returned events 98. The returned events 98 may be organized based upon the sort, group by feature in the event search fields 96 previously discussed. As shown, the returned events 98 are organized via courthouse type first and then date second. Each of the returned events 98 includes a date and time of the event, names of the plaintiff and defendants, the case I.D. number, the status, the fee that was received or will be received by the appearance attorney 16 for appearing at the event, and a selection button. The returned events 98 also include a field that is shown titled by the name “action.” Here, the user may assign settings in the action field to events that are checked in the select, deselect boxes. For instance, the dropdown arrow next to the action field may include items such as accept fee, cancel event, or revert to submitted. The user can select the desired action and then select a particular event via the select, deselect button next to the event, and then click on the “apply to selected” button in order to assign the desired action to a particular event.

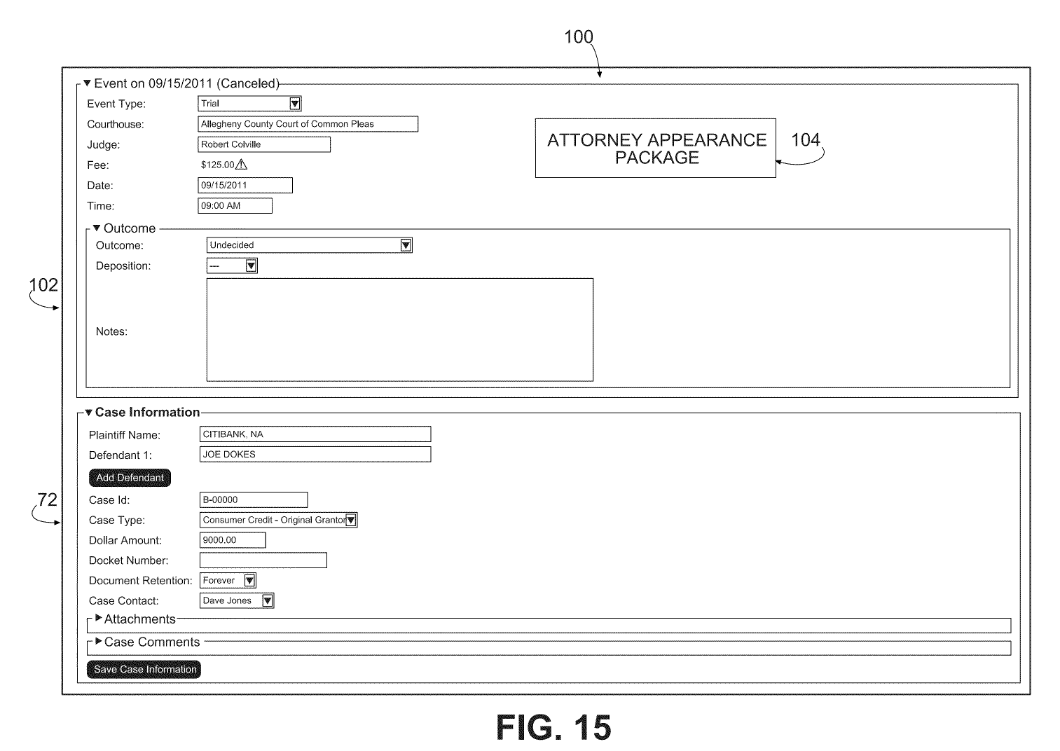

In order to obtain additional information regarding the event on the event results screen 96, the user may click on a particular event. Doing so will cause a popup window to be displayed, one such exemplary embodiment is shown in FIG. 15 as a selected event screen 100. The selected event screen 100 includes a series of selected event fields 102. The selected event fields 102 provide additional information on the selected event. Further, certain ones of the selected event fields 102 can be modified by the user in order to change data on that particular event. The selected event fields 102 include an event type, the courthouse, the judge assigned to the event, the fee that was received by the appearance attorney 16 or that will be received by the appearance attorney 16 for the event, the date and time of the event, and the outcome of the event. The outcome may include a type as previously described with respect to FIGS. 12a and 12b, and can include the disposition and any notes that a user may enter regarding that particular outcome or event. The selected event screen 100 also includes an attorney appearance package 104. Clicking on the attorney appearance package 104 causes certain documents to be printed, as will be momentarily discussed, that relate to the particular event that has been selected and that will be attended by the appearance attorney 16. The attorney appearance package 104 may be available for printing of events that are to take place in the future and not past events. In accordance with other exemplary embodiments, the attorney appearance package button 104 may be selected for all events whether they are past events or future events.

The selected event screen 100 also includes case information 72 as previously discussed that relates to the case to which the selected event is associated. The case information 72 has been previously discussed and thus a repeat of this information is not necessary. Further, the case information 72 can include attachments and case comments and all of this information may be modified at this location and saved.

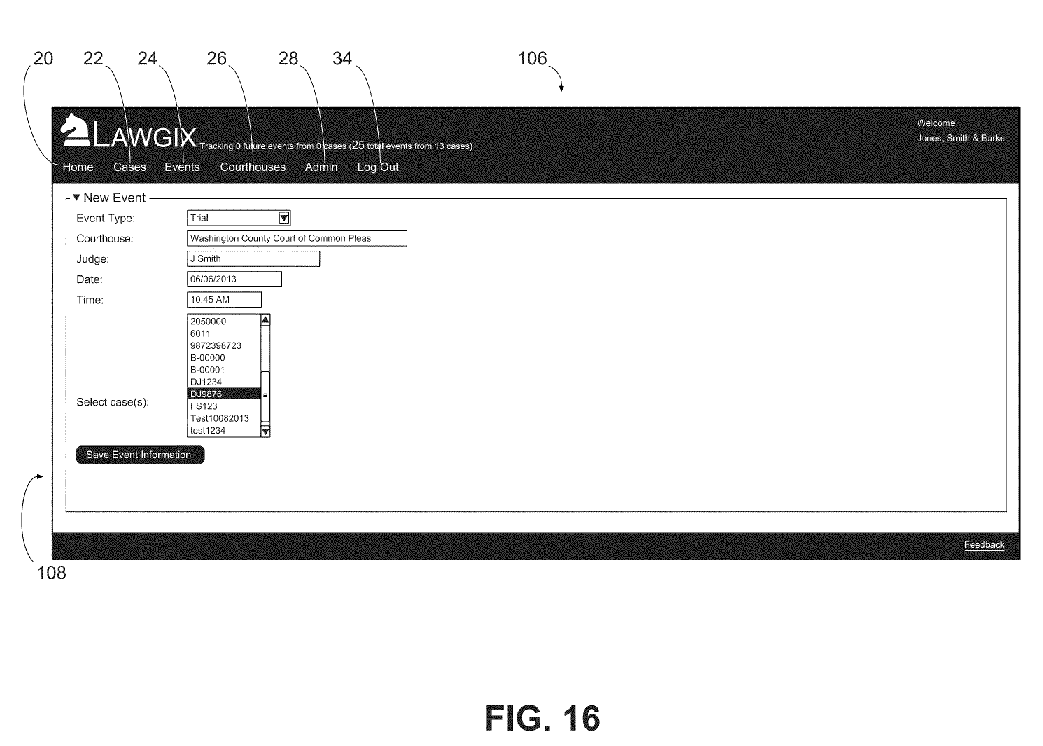

The events tab 24 also includes a selection for the submission of new events. Clicking of the “submit new event” selection of the events tab 24 may cause a submit new event screen 106 to be displayed for the user as shown for example with reference to FIG. 16. The submit new event screen 106 includes a series of submit new event fields 108 that can be filled out by the user in order to add a new event to the machine based system. The user will select an event type that may be, for example, an oral argument, an arbitration hearing, a trial, a conference, a magistrate hearing, a deposition, other, filing or scheduling. The submit new event fields 108 also include a courthouse, judge, date and time for the newly created event. Additionally, the user must select the appropriate case in the submit new event fields 108 to which the new event will be assigned.

The events tab 24 may also include an attorney appearance package selection that allows for the printing of an attorney appearance package for a particular event. The attorney appearance package may be printed not only from the events tab 24, but may also be printed from the event results screen 96 via an attorney appearance package button 104 located next to one of the returned events that is eligible for having an attorney appearance package printed therefrom.

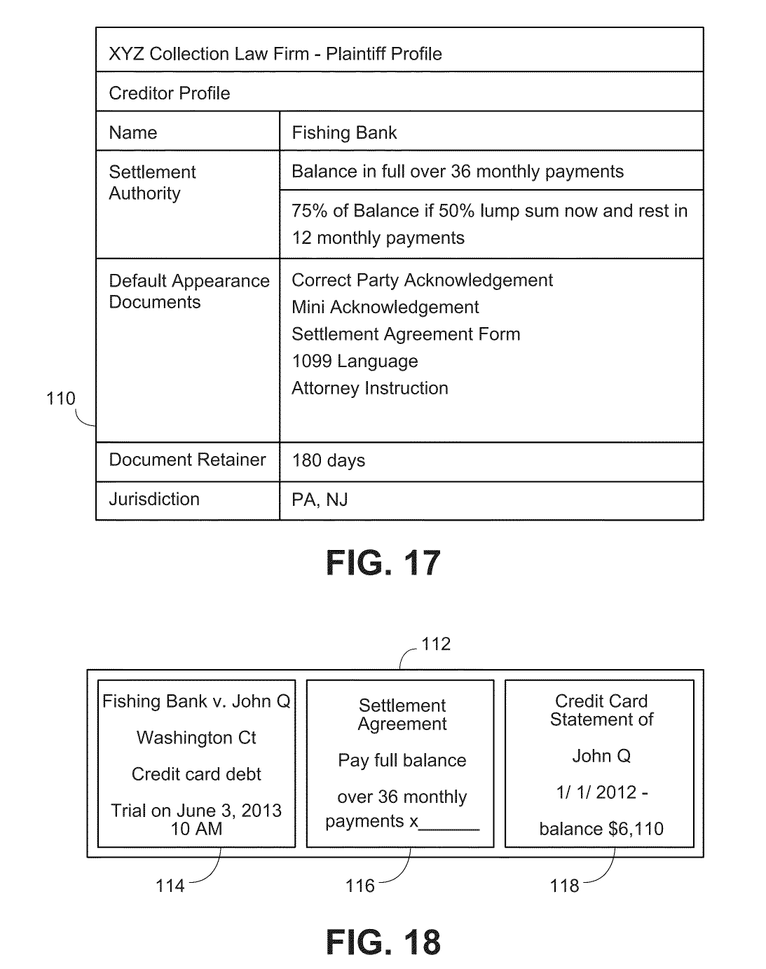

Certain users, such as the collection law firm 14, may be able to access and modify plaintiff profiles through selection of an appropriate item in the administration tab 28. A creditor/plaintiff profile 110 is shown with reference to FIG. 17. The creditor/plaintiff profile 110 may be entered by the particular collection law firm 14 hired by the plaintiff/creditor 12 and thus the creditor/plaintiff profile may be different for the same creditor/plaintiff among different collection law firms 14. The creditor/plaintiff profile 110 includes the name of the creditor along with the settlement authority that the creditor 12 gives to the collection law firm 14. The settlement authority may be different for different amounts of money or may be different for different types of debts due in specific cases. The creditor/plaintiff profile 110 may also include default appearance documents. The default appearance documents may include a right party contact acknowledgment that the appearance attorney 16 may use to ensure that an appropriate agent of the defendant/debtor is communicated with in the particular case. A mini-acknowledgment may also be included in the default appearance documents along with settlement agreement form, 1099 language, and appearance attorney 16 instructions that provide the appearance attorney 16 with guidance on proper procedures for conducting himself or herself in the litigation. The creditor/plaintiff profile 110 may also include the document retention policy of the creditor 12 which may be the length of time that documents for the particular case are to be retained. Also, the creditor/plaintiff profile 110 may include the states or areas of jurisdiction that the creditor 12 has employed the collection law firm 14 in which to represent them in collection matters. The creditor/plaintiff profile 110 may be initially set with default settings and may be able to be revised by the collection law firm 14 and additional information or fields of the creditor/plaintiff profile 110 can be added by the collection law firm 14 in order to provide customization.

The machine based system 10 may be arranged so that creditor 12 accounts can be set up in the collection law firm 14. Data from the creditor 12 can be sent to the collection law firm 14 and stored in these accounts for access by the collection law firm 14. Instructions from creditors 12 on how to handle debtors can be sent down to the appearance attorney 16 through the machine based system 10. Likewise, information on how the debtor responded or answered questions may be sent by the appearance attorney 16 back up to the creditor 12 via the machine based system 10. Users at inbetween points such as the collection law firm 14 or appearance law firm 15 may or may not have access to this information.

In some arrangements, the machine based system 10 may be set up so that the creditor 12 can restrict activity of the collection law firm 14 and associated appearance attorney 16 to specific states. In this regard, the creditor 14 may wish to have a particular collection firm 14 operate on their behalf only in Pennsylvania and not any other states. This information can be input through an administration tab 28 and may show in the creditor/plaintiff profile 110 of the collection law firm 14 so that the particular collection law firm 14 knows which jurisdictions they are allowed to conduct collection litigation in for the particular creditor 12.

As previously discussed, the machine based system 10 may include the ability to print an attorney appearance package 112. The appearance package button 40 is present in the newsfeed 36 of one or more of the home pages 18 as previously discussed. Additionally, the attorney appearance package button 104 may be found on the selected event screen 100, or may be present on the event results screen 96. Further, the ability to print the attorney appearance package 112 may be located at other areas of the machine based system 10. FIG. 18 shows an attorney appearance package 112. The attorney appearance package 112 may be a stack of papers that is printed by the appearance attorney 16 to aid him or her when appearing at the particular event in question. The attorney appearance package 112 may include a case coversheet 114 that has certain information about the case in which the appearance attorney 16 is appearing such as the plaintiff, defendant, court, dispute over which the creditor 12 is seeking payment on, the event, and the time and date of the event. Additional items may be present in the case coversheet 114. The case coversheet 114 may be a single sheet of paper in certain exemplary embodiments or may be made of multiple pages of paper in other exemplary embodiments. The attorney appearance package 112 may also include appearance documents 116 such as a settlement agreement. The appearance documents 116 may be default appearance documents that are drawn from the default appearance documents of the creditor/plaintiff profile 110. The attorney appearance package 112 may also include all of the case attachments 118 of the case that relate to the particular event. For example, the credit card statement of the debtor may be a case attachment 118. All of the case attachments of the case to which the event is part of can be supplied in the attorney appearance package 112.

The machine based system 10 may also include a compliance vault that may be accessed through the administration tab 28. The compliance vault may be accessible only by the collection law firm 14 in accordance with certain exemplary embodiments. In accordance with other exemplary embodiments, the creditor 12 and/or appearance attorney 16 may also have access to the compliance vault. The compliance vault may store compliance records and data for each of the appearance attorneys 16. The compliance vault may store state admission data and bar number or ID number for the particular appearance attorney 16. Also included in the compliance vault is a copy of an insurance declaration page for the particular appearance attorney 16, or appearance law firm 15. The insurance policy expiration date may also be included in the compliance vault and may be used for providing a reminder as to when the insurance needs to be renewed. The compliance vault may also include signed engagement letters for each of the collection law firms 14 in the appearance attorneys 16 jurisdiction. If a signed engagement letter is not present then the appearance attorney 16 cannot be assigned to the events of the collection law firm 14 that are included in the particular jurisdiction. The compliance vault may also include copies of the last training certificate issued by the administrator of the machine based system 10, along with the expiration date of the particular certification of the machine based system 10 by any of the users. The compliance vault may be in some exemplary embodiments accessible only by an administrator of the machine based system 10 and not by the creditor 12, collection law firm 14, or the appearance attorney 16.

The machine based system 10 may also include attorney profiles that are unique for each one of the appearance attorneys 16. The attorney profiles may be accessible by the collection law firm 14 and can be accessed through the administration tab 28 with certain exemplary embodiments. The attorney profile for a particular appearance attorney 16 may include a picture of the appearance attorney 16. The attorney profile may also include a biographical section of the appearance attorney 16 such as education, residence, professional experience, family, interests and hobbies. The attorney profile may also include a link to compliance documents associated with the particular appearance attorney 16, and a link to send messages to the appearance attorney 16 so that the messages are received in the news feed 36 of the particular appearance attorney 16. The attorney profile may also include a list of the last 10 events, filtered by collection law firm 14, and their outcomes for the particular appearance attorney 16. The courthouse tab 26 may include a selection to “manage” various courthouses included within the machine based system 10. Clicking on the manage button of the courthouse tab 26 allows one to search for various courthouses first via state then via county located within the state. All of the entered courthouses can be selected and updated by either having them removed from the machine based system 10 or added to the machine based system 10. Additionally, the courthouses can be managed in the courthouse tab 26 to assign particular courthouses to the appearance law firm 15 into different regions assigned with the appearance law firm 15. The appearance law firm 15 will then be able to determine which appearance attorneys 16 can in fact handle a particular case as the particular case may be filed in a courthouse to which the appearance attorney 16 has authorization in which to appear. The appearance law firm 15 can then assign an appearance attorney 16 to that courthouse for a particular appearance.

Further, a user at the appearance law firm 15 may click on the courthouse tab 26 to access the manage courthouse page and search through various courthouses that are organized by first state and by second county. If the appearance attorney 16 is authorized to practice in a particular courthouse, the user at the appearance law firm 15 may highlight or otherwise select the courthouse from those illustrated and click on an “update” button in order to cause the selected courthouses to be assigned to the specific appearance attorney 16. This information will be used by the machine based system 10 and can be in turn utilized by the collection law firm 14 when deciding whether a particular appearance attorney 16 can handle a particular case.

The administration tab 28 of the machine based system 10 also includes a firm info button that can be used to update specific information about the particular collection law firm 14, such as the name and address. The firm information button of the administration tab 28 may also be used to select a default document retention policy of the law firm 14 in question. A drop down list may be provided in order to allow for the selection of a number of days for which documents are to be retained by that particular law firm. The administration tab 28 also includes a user button that, if selected, provides information for the particular user or users of the machine based system 10. For example, if used by an appearance attorney 16, the user button will allow the appearance attorney 16 to update or change their user name, display name, email address, telephone number, password, and/or calendar URL. The log out tab 34, if selected, causes the user to be logged out of the machine based system 10.

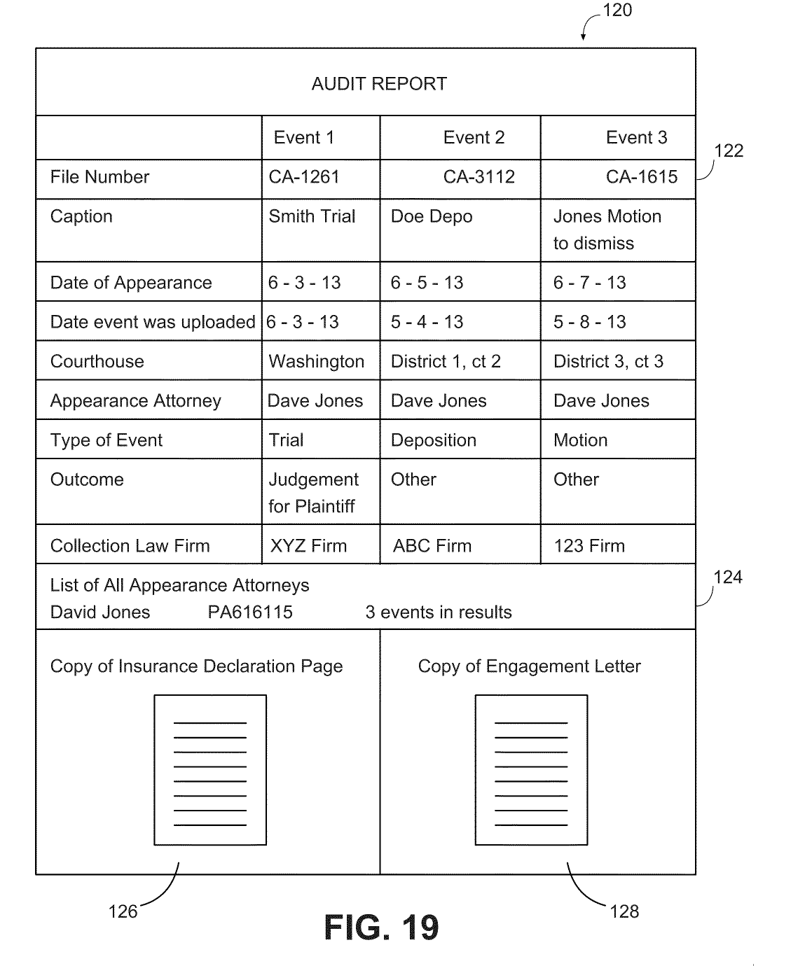

A reports tab 30 may also be included and, if selected, may allow for the generation of various reports from the machine based system 10. Clicking on the audit report under the reports tab 30 may bring up a search criteria page that is similar to the find event screen 64 shown in FIG. 13. The audit report under the reports tab 30 may be accessible by administrators of the collection law firm 14 and by the system administrator of the machine based system 10. The audit report may not be accessible by the creditor 12 or the appearance attorney 16 with certain exemplary embodiments. The search page may have search criteria for the state, plaintiff, defendant, date range of appearance, event type, courthouse, court type and outcome. An exemplary embodiment of an audit report 120 is shown with reference to FIG. 19. Inputting the appropriate information into the search page will cause the audit report 120 to be generated accordingly to the input entered and will be displayed on the machine based system 10. The audit report 120 may also be capable of being downloaded as either a .pdf or .xls file in accordance with certain exemplary embodiments. The audit report 120 may include a list of all of the events that meet the search criteria as previously entered on the search page. Each one of the events may include event items 122 as shown in FIG. 19. The event items 122 can include the file number, caption, date of appearance, date the event was uploaded, courthouse, appearance attorney 16, type of event, and outcome of the event. The event items 122 for each of the events may also include the collection law firm 14 that is associated with that particular event. The collection law firms 14 may only be able to be viewed by the administrator of the machine based system 10 and the creditor 12. The collection firm 14 in the audit report 120 may not be viewable by the collection law firm 14 or the appearance attorney 16.

The audit report 120 may also include an appearance attorney list 124 that lists all of the appearance attorneys 16 in the results obtained upon entry of the information in the search page as previously discussed. The appearance attorney list 124 may include the name of the appearance attorney 16, the state bar ID of the appearance attorney 16, and a tally of the events attended in the result list. The audit report 120 may also include, as shown, an insurance declaration page 126 that covers each one of the appearance attorneys 16 that are shown on the audit report 120. The copy of the insurance declaration page 126 may be obtained from the compliance vault as previously discussed. Also included in the audit report 120 at the lower right hand corner is an engagement letter page 128. The engagement letter page 128 includes a copy of the engagement letter between the collection law firm 14 and each of the appearance attorneys 16 that are returned in the results and thus appear in the audit report 120. The copy of the engagement letter 128 may be obtained from the compliance vault as previously mentioned.

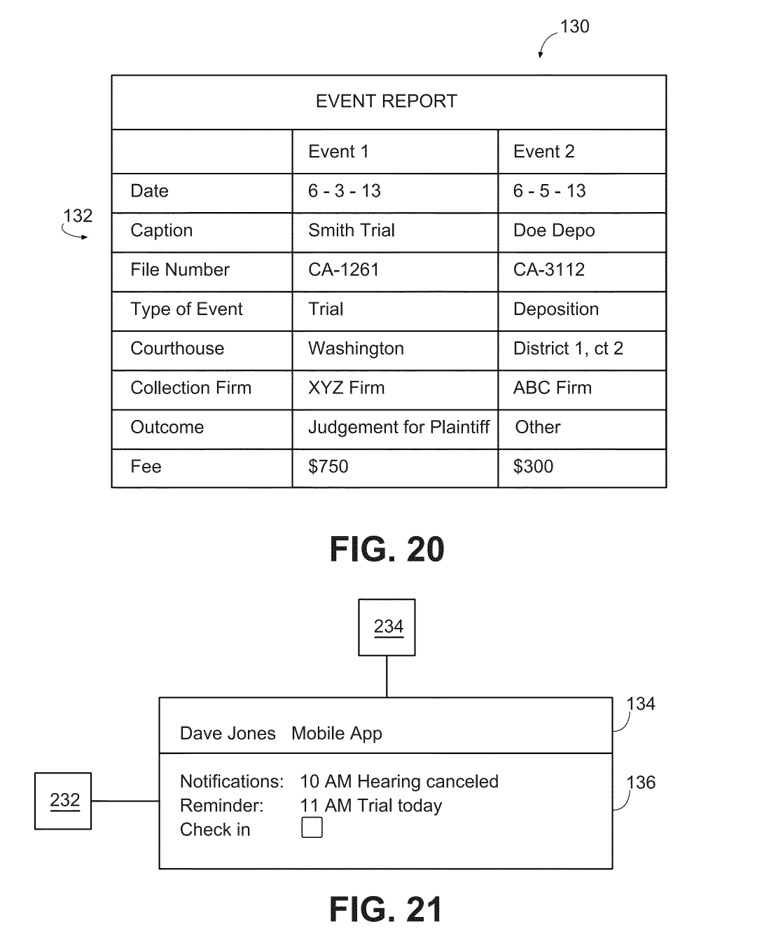

Another report that may be accessible through the reports tab 30 is an event report 130 as show for example in FIG. 20. The event report 130 may be accessible by the creditor 12, administrators of the machine based system 10, and the collection law firm 14. The event report 130 may not be obtainable by the appearance attorney 16 in certain exemplary embodiments. Events can be searched via a search page similar to the one previously discussed with respect to the find events screen 64. Entry of search criteria for determining the events may cause the event report 130 to be displayed on the screen and may also be downloadable as a .pdf or .xls file. For every event that is returned as per the search criteria entered, the event report 130 will include that particular event along with certain event information 132 that relates to the particular event. The event information 132 that is displayed in the event report 130 for each event includes the date, caption, file number, type of event, courthouse, collection law firm 14, outcome, and fee for the event. In accordance with certain exemplary embodiments, the collection law firm 14 of the event information 132 may be accessible only by the administrator of the machine based system 10 and may not be accessible or shown to the creditor 12, collection law firm 14, or appearance attorney 16. The event report 130 along with the audit report 120 may be printed out by the user for reference as desired.

The reports tab 130 may also be selected in order to allow for a billing report to be shown. The billing report may be accessible only by the administrator of the machine based system 10 in accordance with certain exemplary embodiments.

The machine based system 10 may also include a help tab 32 that may appear for all users of the machine based system 10. The machine based system 10 may also include a help desk that may be accessed under the help tab 32. All users of the machine based system may be able to create help tickets that can be attached to cases. Help tickets that are created by the collection law firm 14 must be attached to a specific courthouse and the machine based system should direct the help ticket to the appropriate creditor 12 or collection law firm 14 based on the courthouse to which the help ticket was attached. Further, the creditor 12 or collection law firm 14 that was assigned to the help ticket should likewise be attached to the help ticket and the particular appearance attorney 16 can likewise be attached or assigned to the help ticket. Selection of the appearance attorney 16 that is assigned to the help ticket may be by the system administrator.

Administrators of the machine based system 10, the creditor 12, and appearance attorney 16 can also create help tickets and must attach these help tickets to both a courthouse, a collection law firm 14, an event, and a case. The administrators of the machine based system 10 may be able to search and/or browse all of the help tickets that are created. The help tickets include content that request help in a particular case or event or provide instructions regarding a particular case or event. The machine based system 10 may be utilized by a user at his or her office by accessing a computer. The machine based system 10 also provides additional utility if it is allowed to be used in various places for mobile functionality. For example, the machine based system 10 may be used by an appearance attorney 16 who travels from courthouse to courthouse to access information on the particular event(s) they are attending at that particular courthouse and to update the machine based system 10 immediately while at the particular courthouse. The court that the appearance attorney 16 appears in may be a court of common pleas or any other court capable of handling a collection litigation matter. An appearance attorney 16 may utilize a laptop, cell phone, PDA, iPhone, Blackberry, or other mobile computing device. The mobile computing device may be part of the machine based system 10 and provide the appearance attorney 16 with mobile functionality.

With reference to FIG. 21, a mobile device display 134 is shown that may be items displayed to an appearance attorney 16 on his or her cell phone, PDA or other portable device. The mobile device that the appearance attorney 16 uses as part of the machine based system 10 may be internet-enabled and may have a GPS and touch screen capabilities. A mobile app will be installed on the appearance attorney 16 device and may require a pin or password authentication upon each use. The entire portions of the machine based system 10 that are accessible by the appearance attorney 16 may be likewise accessible on the mobile device of the appearance attorney 16. However, the mobile device may be provided with the mobile app in order to better utilize the machine based system 10 for the appearance attorney 16 when at a courthouse or otherwise outside of his or her office.

As shown in FIG. 21, the mobile device display 134 includes an appearance attorney check in page 136 that provides notifications for changes or cancellations that were made to events that were assigned to or otherwise scheduled to the appearance attorney 16. The notifications that are displayed may be based upon scheduled events for that day or time of the particular appearance attorney and may in fact be generated based upon the physical location of the mobile device of the appearance attorney 16. The appearance attorney check in page 136 may also include reminders for upcoming events that are scheduled to the appearance attorney 16. When the appearance attorney physically arrives at a scheduled hearing location, such as a courthouse, the mobile app will prompt the appearance attorney 16 to “check in”; this may be made through the actuation or selection of a check in box on the appearance attorney check in page 136.

The machine based system 10 may include a GPS component 232 that is capable of transmitting location based information. The GPS component 232 may utilize signals associated with one or more GPS satellites in order to arrive at location information. This location information may be associated with the mobile device by being transmitted to the mobile device, or being physically present with the mobile device. In this manner, once the location of the GPS component 232 is known, the location of the mobile device is necessarily known. Once the appearance attorney 16 checks in, the GPS location of the appearance attorney 16 obtained from the GPS component 232 may be sent to a database of the machine based system 10 in order to verify that the appearance attorney 16 is in fact in the location where the event is to take place. Notice of the appearance attorney 16 check in may include the name of the appearance attorney 16, the date, the time, and the location. This information may be displayed on the newsfeed 36 of the appearance attorney 16 or any other user of the machine based system 10.

The mobile device 204 may include an alarm component 234 that provides an alarm to the user of the mobile device 204 upon the happening of a certain item. The alarm may be generated if an event assigned to the user of the mobile device is modified, or may be generated once the event assigned to the user is some designated time away from taking place. The alarm may be an audible alert generated by the alarm component 234.

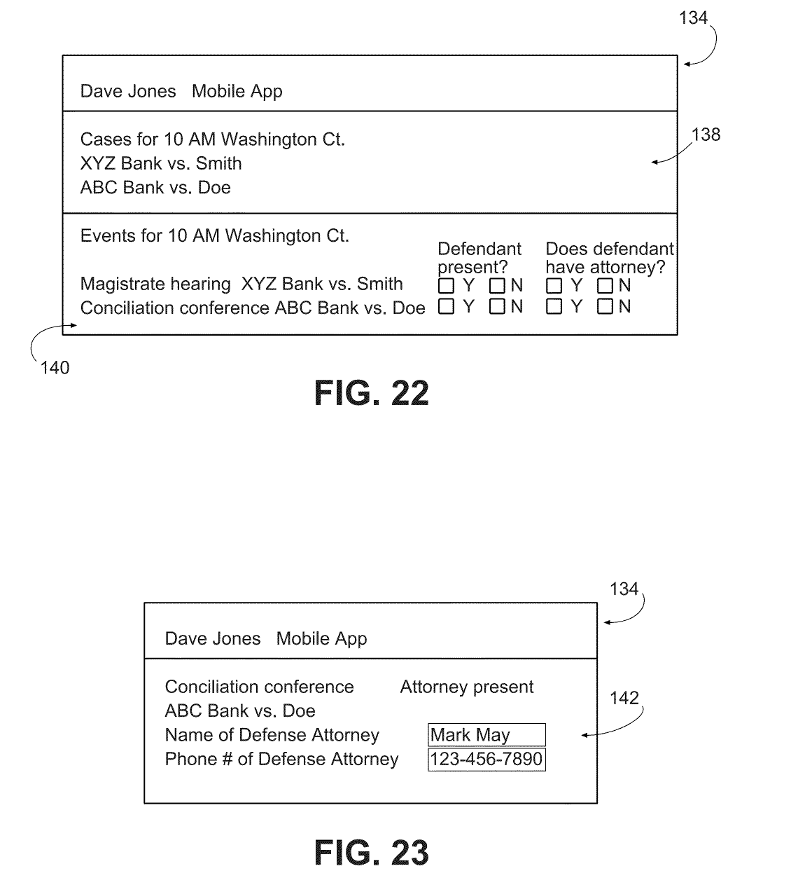

After the appearance attorney 16 has checked in, the mobile app may display an appearance attorney case display page 138 as shown on the mobile device display 134 in FIG. 22. The appearance attorney case display page 138 may include a list of all cases that the appearance attorney 16 has been scheduled for at that particular place and time. Further, events for the appearance attorney 140 may also be displayed on the mobile display device 134. The events for the appearance attorney 140 may be displayed with the appearance attorney case display page 138 or may be a separate page in accordance with various exemplary embodiments. The events for appearance attorney 140 include all hearing related events such as magistrate hearings, arbitrations, conciliation conferences, trials, filing events and scheduling events. The events for appearance attorney 140 may not include non-hearing related events. The mobile app will prompt the appearance attorney 16 to mark which defendants for that particular event are present. As shown in FIG. 22, the appearance attorney 16 may be presented with a yes or no check box next to the event in the events for appearance attorney 140 to indicate whether or not the defendant is present. If the defendant is in fact present, the appearance attorney may then be asked to select a separate check box to answer whether or not the defendant has an attorney. These two questions may be presented to the user on the mobile display device 134 at the same page, or subsequent pages may be presented to the user to answer these questions and receive the appropriate input.

If the defendant does have an attorney for a particular event, the mobile app will prompt the appearance attorney 16 to collect the defense attorney name, address, and phone number. With reference now to FIG. 23, the mobile device display 134 shows defense attorney information page 142. The event in question is displayed and is noted as having an attorney present for the defendant. The name of the defense attorney can be input into the defense attorney information page 142 by the appearance attorney 16, and the phone number and address of the defense attorney can likewise be input into a field of the defense attorney information page 142 by the appearance attorney 16.

The mobile app will allow the appearance attorney 16 to filter the list of cases in the appearance attorney case display page 138 based upon the status of the defendants that are present. In this regard, the appearance attorney 16 may be able to focus on cases where the defendants are present first. As such, cases in the appearance attorney case display page 138 may be reorganized after entry of the events for appearance attorney 140 information so that those cases in which a defendant is in fact present are listed first before those cases where the defendant is not present. The appearance attorney 16 may then work on cases where the defendant is in fact present, and then later allow for updating of cases where the defendant is not present.

The appearance attorney 16 may select a case to work on from the list of cases and then will be redirected to a series of modules that will handle the event in question. Although the appearance attorney 16 may select the first case on the list that may show that a defendant is present, the appearance attorney 16 may also be given the option of selecting any case on the list of cases for the appearance attorney 138 and thus is not bound by the order provided by the mobile app.

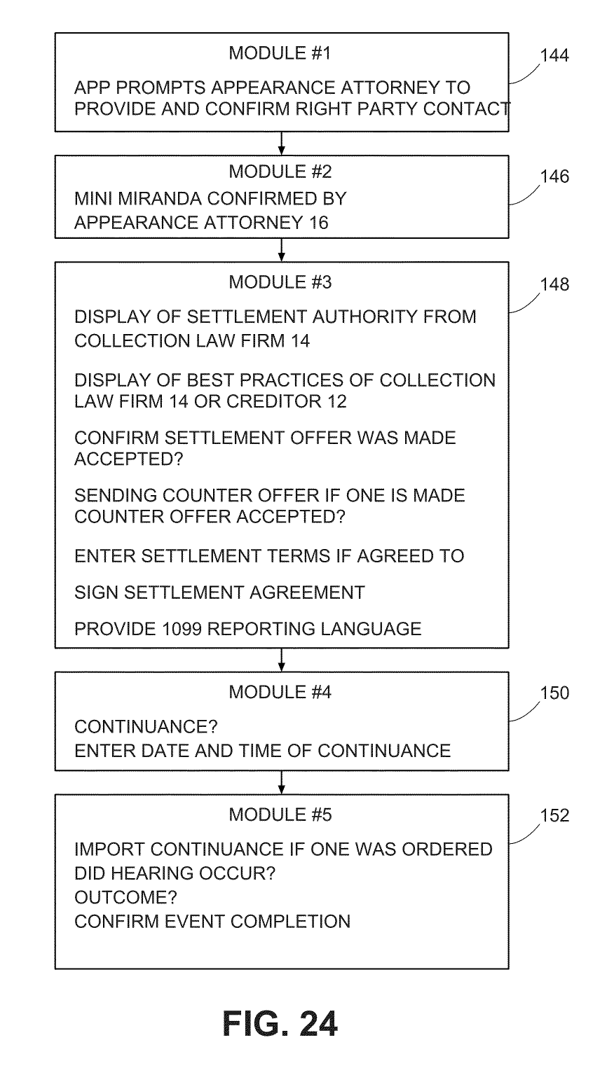

FIG. 24 shows a series of modules that the mobile app can go through to guide the appearance attorney 16 on the handling of a particular event and to obtain input from the appearance attorney 16 so as to properly update the event in the machine based system 10. The modules shown in FIG. 24 may be run on the processor of the mobile device of the appearance attorney 16, on a server of the machine based system 10, or on a combination of both in accordance with certain exemplary embodiments. Once the appearance attorney 16 selects the first case, and assuming that a defendant is in fact present in the first case, the first module 144 may be implemented by the mobile app. The first module 144 may prompt the appearance attorney 16 to confirm the “right party contact” for the particular case/event that has been selected. The “right party contact” will be a person that is authorized to act on behalf of the defendant in the case that has been selected. The first module 144 may present to the appearance attorney information related to the defendant in order to allow for a confirmation that the right party contact has been made. The mobile app will ask the appearance attorney 16 to confirm the right party contact so that the machine based system 10 in turn, once confirmed, posts in real time such information related to the event so that other users of the machine based system 10 can ascertain that the right party contact has been made for this particular event. After confirmation of the right party contact in module 1, the mobile app may move to the second module 146. The second module 146 will prompt the appearance attorney 16 to provide a “mini Miranda.” The second module 146 will then prompt the appearance attorney to confirm the mini Miranda. The “mini Miranda” may be a warning to the defendant that the appearance attorney does not represent the defendant, but rather the creditor/plaintiff. The “mini Miranda” may also be language that the appearance attorney tells the defendant to make sure certain collection law warnings are given. Once the mini Miranda is confirmed, this confirmation will be posted in real time to the event such that the event in the machine based system 10 is updated appropriately.

The mobile app will then move from the second module 146 to the third module 148. If it was the case that the defendant for the selected case did in fact have a defense attorney, the first and second modules 144 and 146 may not be utilized by the mobile app and instead the mobile app will go directly to the third module 148 without presenting the first or second modules 144, 146 to the appearance attorney 16.

The mini Miranda may provide information to the right party contact that may explain the appearance attorney 16 role in the litigation and may advise the right party contact that the appearance attorney 16 does not represent the defendant and instead represents the collection law firm 14 and/or the creditor 12 and thus may advise the defendant that he or she should retain a lawyer for handling the present matter.

The third module 148 that is implemented by the mobile app relates to settlement matters of the litigation. The third module 148 may display settlement authority received from the collection law firm 14, or from the creditor 12 on the particular matter. The mobile app when implementing the third module 148 may prompt the appearance attorney 16 to discuss settlement with the defendant. The third module 148 may also display any unique or custom instruction requirements for defendant communication as required by the collection law firm 14 or creditor 12 and thus may provide the “best practices” to the appearance attorney 16. This instruction may allow the appearance attorney 16 to conduct himself or herself in a manner that both complies with the law and with the desires of the particular creditor 12 or collection law firm 14 as the principals may wish the appearance attorney 16 conduct himself or herself in a desired manner.

The settlement information provided by the third module 148 may allow the appearance attorney 16 to make a settlement offer in accordance with those instructions to the defendant in order to settle the current litigation or otherwise handle the current event. The third module 148 may provide a screen or other check point that allows the appearance attorney to confirm that a settlement offer was made to the defendant. This information may likewise be uploaded to the machine based system 10 so that other users of the machine based system 10 know that a settlement offer was made. The third module 148 will then ask the appearance attorney whether the offer was accepted, or whether the offer was refused, and if the offer was refused whether a counteroffer was made. Assuming that the offer was refused and a counteroffer was made, the mobile app will allow the appearance attorney 16 to send terms of the counteroffer to the collection law firm 14 and/or creditor 12 via email or other means such as uploading this information into the machine based system 10. The collection law firm 14 and/or creditor 12 may then in turn notify the appearance attorney of any change in settlement authority through the mobile app. It is expected that some amount of time may need to take place for the collection law firm 14 or creditor 12 to make this decision and revise settlement authority. During this time, the appearance attorney 16 can move on to other cases that he or she is assigned to at this particular time.

Assuming that settlement terms are agreed to by the defendant and the appearance attorney 16, the mobile app will prompt the appearance attorney 16 to enter all relevant terms of the settlement. The mobile app in module three 148 will generate a settlement agreement that may be in .pdf format and may request that the defendant and appearance attorney 16 sign the agreement using their fingers on a touch screen. Alternatively, such settlement agreement may be able to be printed out by the appearance attorney 16 and physically signed. Assuming that an electronic copy of a settlement agreement has been signed by the defendant and the appearance attorney 16, a copy of the settlement agreement can be emailed to the defendant and may also be posted in real time to the event information for the case in question on the machine based system 10. If the collection law firm 14 or creditor 12 requires 1099 language, the mobile app will prompt the appearance attorney to provide the defendant with 1099 reporting language and include this information in the settlement agreement as well, AD information related to the settlement of the third module 148 may be exported to the fifth module 152 that may be a dynamic outcome reporting module.

If no settlement is reached, the mobile app will move from the third module 148 to the fourth module 150. Also, if the case that is being worked on is one in which the defendant does not appear, the mobile app will move directly to the fourth module 150 and will not present the first, second or third modules 144, 146 and 148 to the appearance attorney 16.

The fourth module 150 prompts the appearance attorney as to whether or not the case was or is to be continued. If there are no continuances in the present case, the mobile app will move to the fifth module 152. If there is a continuance in the present case, the mobile app will prompt the appearance attorney to enter the new date and time (if available) of the event. The mobile app will automatically create a new event for the schedule collection firm 14 using the new date and time and will mark the new event with “accept fee” status. All information regarding the continuance will be displayed in real time on the event information section of the machine based system 10. Further, this information will be exported to the dynamic outcome reporting module 152.

The fifth module 152 is the outcome module and will first receive information from the fourth module 150 regarding a continuance. The fifth module 152 may ask the appearance attorney 16 whether or not a hearing occurred. If a hearing did in fact occur, the fifth module 152 may then ask the outcome of the hearing. The outcomes may be those as previously discussed. If a hearing did not occur, the mobile app will ask what other outcome did in fact occur. The various outcomes, such as those shown and described with reference to FIGS. 12(a) and 12(b), may be input by appearance attorney 16 in the mobile app in the fifth module 152 and the machine based system 10 can be appropriately updated. The fifth module 152 may also ask the appearance attorney 16 to confirm that the event in question is complete. After this step, the mobile app may be done implementing the five modules 144, 146, 148, 150 and 152 and the appearance attorney 16 may be then presented with the appearance attorney case display page 138 so that the next case in the list can be selected and information obtained therefrom in a like manner.

The appearance attorney 16 may also select events from the events for appearance attorney 140 on the appearance attorney case display page 138 that are hearing and non-hearing type events such as motions, filings, or a trial. All events, whether they are hearing or non-hearing events, may go through the various modules. The mobile app may allow the user to access events that occur during the particular time and at the particular place the appearance attorney 16 is located. Alternatively, the mobile app may allow the appearance attorney 16 to access any events to which the appearance attorney 16 is assigned. For non-hearing type events, the mobile app will prompt the appearance attorney 16 to mark which defendants, if any, are present. The mobile app will next direct the appearance attorney to ask if any of the present defendants has an attorney, and if so will collect the opposing counsel's name, phone number, firm name, and address. The mobile app may allow the appearance attorney to filter the returned cases based on the status of whether or not the defendant is present. As previously stated with respect to the hearing type events, this filtering may allow the appearance attorney 16 to focus on cases in which the defendants are first present, and then later may allow the appearance attorney 16 to input information on those cases in which the defendant is not present. For events in which the defendant is present, the mobile app may for the non-hearing events move through modules 144 and 146 as previously discussed. The mobile app may not move to the third module 148 or the fourth module 150 because a settlement or a continuance is not applicable to non-hearing type events. Instead, the mobile app may move directly from the second module 146 to the fifth module 152 and ask the user to input the outcome of the matter and confirm that the event has been completed. If the defendant is not present for the non-hearing type event, the mobile app may move directly to the fifth module 152 and prompt the appearance attorney 16 to enter the outcome of the event and confirm that the event has been completed. The mobile app may not execute the first module 144, the second module 146, the third module 148 or the fourth module 150 for those instances where a non-hearing type event occurs and defendant is not present.

The mobile app in addition to providing the various modules 144, 146, 148, 150 and 152 to the appearance attorney 16 may also allow the appearance attorney 16 to have access to all case and event information in the machine based system 10. The mobile app may also allow the appearance attorney 16 access to all uploaded documents, comments and notes in the machine based system 10. The mobile app may further provide the appearance attorney 16 with other tools that he or she may use in the litigation. For instance, the mobile app may provide the appearance attorney 16 with a calculator, calendar and an add event/case widget. The mobile app may also include a notepad and all notes generated by the notepad may be posted to case info on the machine based system 10. The mobile app may also include a “cam scan” that allows the appearance attorney to scan court documents that are present on paper so that these documents can be input electronically into the data base of the machine based system 10. The mobile app may also include a stopwatch that allows the appearance attorney 16 to document the time for the particular appearance. Also included may be a mileage calculator that allows the appearance attorney 16 to calculate the number of miles traveled to and from the event. Location information from the GPS component 232 can be transmitted to the mileage calculator. The location information may be obtained from using the GPS feature of the mobile device to which the mobile app is integrated. The mobile app may also provide access to proprietary analytical materials and a case law vault that is organized by topic and jurisdiction. The mobile app may also provide the appearance attorney 16 with access to the appearance attorney's message system of the machine based system 10. The appearance attorney 16 may also be able to access his or her newsfeed 36, a court locator, and a phonebook directory of all collection firm information in their particular state through the mobile app.

Instructions given by the first and second modules 144 and 146 may help ensure the appearance attorney 16 complies with the Fair Debt Collection Practices Act as the information provided by the first and second modules 144 and 146 may relate to items that need to be addressed or should not be addressed as per the Fair Debt Collection Practices Act. The mobile app allows the collection law firm 14 and the creditors 12 to verify that the appearance attorney 16 did in fact show up to the event in question for which the appearance attorney 16 is being paid. The mobile device 204 that the appearance attorney 16 uses to implement the mobile app may include GPS functionality and location data. A GPS component 232 can be in communication with the mobile device 204 in order to provide location data that would in turn be assigned as the location of the mobile device 204 by the machine based system 10. A camera 230 may be in communication with the mobile device 204. A user, such as an appearance attorney 16, may use the camera 230 to capture an image of a document and cause this image to be stored in the memory 220 and/or memory 208. The image may be associated with the event or case in question as other documents previously described. The camera 230 may be part of the mobile device 204 or may be a machine component that is not integrally formed with the mobile device 204. The camera 230 may be used to capture images related to the event or case other than document images, and these other mages may stored in the memories 220, 208.

The mobile device 204 may include an alarm component 234 that communicates an alarm to the user of the mobile device 204 upon the happening of some predefined set of circumstances as previously discussed. The alarm component 234 may be in communication with the mobile device processor 218. In some instances, the alarm component 234 may be the same component as the processor 218. In other instances, the alarm component 234 may be a speaker of the mobile device 204, or may be the same component as the mobile device display 222. The alarm component 234 need not be physically connected to the mobile device 204 but may simply be a component, such as an email server, SMS server, or an instant messaging server that delivers an alarm to the user when desired by the system 10.

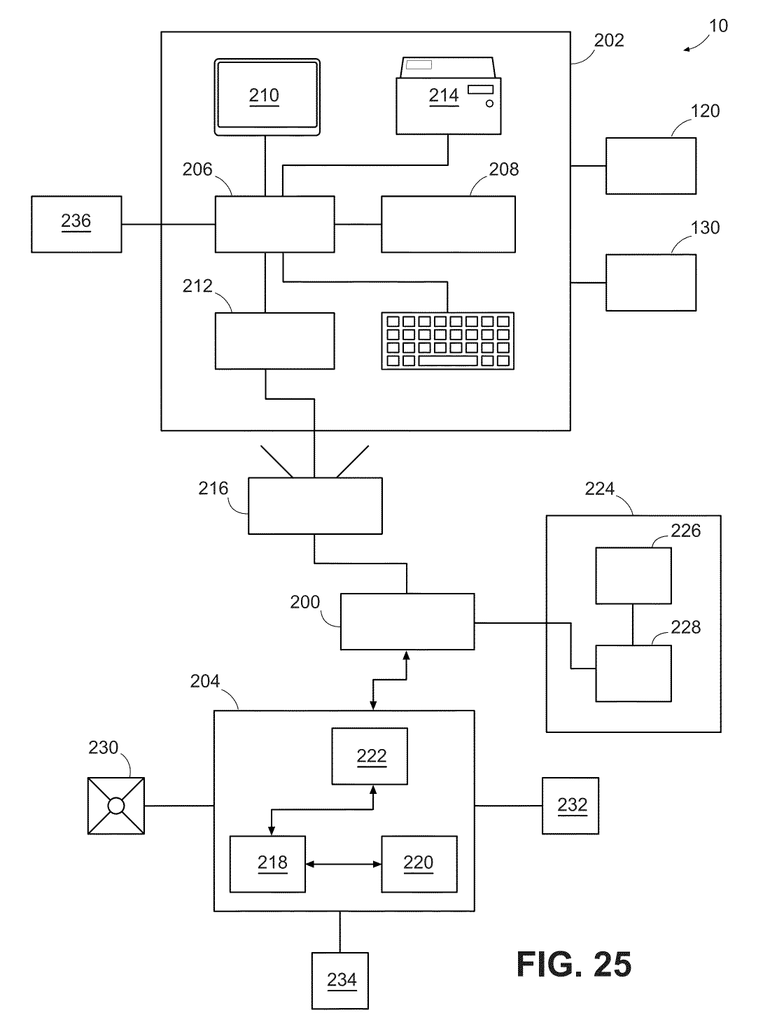

The various methods and machine based system 10 previously discussed may be carried out by a computer or by a series of computers connected to one another through a network 200 in accordance with certain exemplary embodiments. FIG. 25 illustrates a machine based system 10 constructed and arranged to execute and manage the mobile platform for collection litigation system. Two different user computer systems 202 and 204 are illustrated. Either one of, or both, of the user computer systems 202 and 204 can be used by the user to implement the machine based system 10. A user computer system 10 includes a user processor 206 that is in communication with a user memory 208, a user display 210, and a user interface card 212. This particular user computer system 202 may be, for example, a PC located in the home of the user. The user processor 206, and other processors described herein, may be a piece of hardware that can execute readable machine instructions for performing various steps and functions. The user processor 206 may include but need not be limited to a microprocessor, a computer server, a digital signal processor, or combinations thereof. The user processor 206 may comprise one or more processors, which may comprise part of a single machine or multiple machines. The user processor 206 is not a signal, but is instead a physical object. The user display 210 may be a piece of hardware. Further, the user display 210 can be a graphical user interface in accordance with certain exemplary embodiments.

The user processor 206 may be in communication with an alarm component 236 that generates an alarm such as an audible alarm, a visual alarm, a text message alarm, or an email alarm. The user processor 206 may send an instruction to the alarm component 236 to cause the alarm component 236 to actuate the alarm. The instruction to send an alarm can be given if the user processor 206 determines any type of predefined event has occurred such as the impending happening of an event, the change of information related to an event, the assignment of an outcome to an event, or if appearance location information input by a user does not match appearance location provided by a GPS component 232.

The user memory 208 may be solid state memory, random access memory, and/or a database in accordance with different embodiments. The user memory 208 may be a physical object and does not include signals. The user processor 206 and the user memory 208 are not executable applications but instead are hardware that are operable for carrying out instructions. A user printer 214 is also in communication with the user processor 206 and can be used to print out reports or other documents such as the audit report 120 or the event report 130. The user processor 206 can read the user memory 208 and display this information on the user display screen 210. The user printer 214 and the user display screen 210 are pieces of hardware that are located in the machine-based system 10. User interface card 212 can be in communication with a router 216 or other device to allow for communication with a network 200. Network 200 could be a public switched telephone network, the Internet, or a local area network in accordance with certain exemplary embodiments.

Another example of the user computer system 204 is shown in FIG. 25 as having the mobile device processor 218, the mobile device memory 220, and the mobile device display 222, and may be a mobile device such as a PDA, cell phone, or smart phone. The mobile device memory 220 may have an application stored thereon that allows him or her to implement the machine-based system 10. The mobile app previously discussed may be stored on the mobile device memory 220. The mobile device display 222 may be a touch screen that allows the user to both view information and input information through a series of soft keys. The mobile device processor 218 is in communication with the mobile device memory 220 and the mobile device display 222, and the mobile device 204 may be connected to the network 200 to receive information from and to send information to other items of the machine based system 10. The user can use the mobile device 204 outside of his or her home or office and thus the system 5 may provide mobile functionality.

A collection litigation server 224 is incorporated into the machine-based system 10 and includes a collection memory 226 that is in communication with a collection processor 228. Again, other hardware as previously discussed may be incorporated. The collection litigation server 224 is in communication with the other components of the machine-based system 10 via the network 200 connection to the collection processor 228. Data such as events, cases, appearance attorney assignments, settlement authorization, settlement agreements, best practice instructions, and courthouses may be stored in the collection memory 226. Although described as being a separate component, the collection litigation server 224 may be part of the user computer system 202 and need not be a separate component that needs to be accessed over a public network 200. Instructions for implementing the machine based system 10 can be included on the collection memory 226, and the collection server 224 may function to operate various portions of the machine-based system 200.

Various elements, such as software and data, can be stored in any one of or multiple ones of the memories 208, 220, 226. The case information, event information, compliance documents, mobile application modules, and reports may be stored on any one of or various ones of the memories 208, 220, 226. The various processors 206, 218, 228 can access information stored in the memories 208, 220, 226 and can transfer this information to other ones of the processors 206, 218, 228. Although single processors and memories are disclosed as making up the various computers and servers 202, 204, 224, in other arrangements multiple processors and memories may be present. Further, multiple computers and servers may make up the various computers and servers 204, 202, 224 and they need not each be made up of a single computer or server. The various instructions, software, data, and interactions discussed with reference to FIGS. 1-25 can be implemented on the processors and memories 208, 220, 226, 206, 218, 228 discussed in relation to the particular computer or server 202, 204, 224 that implements the stated instructions, software, data or interactions of the process of the machine-based system 10. The machine-based system 10 may include a physical report 120, 130 that is obtained by the user by use of the user printer 214.

The methods and systems described herein can be executed through instructions contained in non-transitory tangible computer readable storage medium. The various memories 208, 220, 226 previously discussed may be this type of memory. The computer readable medium may be an article of manufacture having the capability to store one or more computer programs, one or more pieces of data, or a combination thereof. The computer readable medium may include a computer memory, hard disk, memory stick, magnetic tape, floppy disk, optical disk (CD or DVD), zip drive, solid-state drive, or combinations thereof. The memories described herein may physically change when data is written to the memories such that there is a physical transformation of the memories upon execution of the article of manufacture. The computer readable medium is not a signal and is not and does not include transitory propagating signals. The computer readable medium is not a modulated data signal such as a carrier wave.

The instructions may cause the various processors 206, 218, 228 to perform certain steps as discussed. All of the methods and alternate methods can be carried out in a system using instructions on non-transitory computer readable medium executed by one or more processors. The machine-based system and computer readable medium and the article of manufacture, and methods, disclosed herein require and are limited to use in some manner with a computer. The machine-based system and the article of manufacture and the computer readable medium, and methods, disclosed herein do not include transitory embodiments.

The machine based system 10 may download information when an internet connection is not present. In this regard, various portions of the machine based system 10 can operate to obtain information and store this information for subsequent movement throughout the system 10 once an Internet connection is in fact present. Conversely, the machine based system 10 may work in real time with data transfer when an Internet connection is present.

The machine based system 10 can be used in a variety of industries for the collection of various debts. For example, the machine based system 10 can be used in the collection of governmental obligations, retail/consumer debt collection such as credit cards, commercial collections, bankruptcy proceedings, mortgage foreclosure, student loan debt collection, automobile repossession, commercial litigation, insurance subrogation, and tax collections. The machine based system 10 can be used pre-judgment and/or post-judgment.

As stated, the described implementation of the machine based system 10 was with use in collection litigation. This was for describing one exemplary embodiment of the invention. Other legal systems may be utilized with the machine based system 10 in other embodiments. For instance, the machine based system 10 can be used in bankruptcy litigation to facilitate appearances by appearance attorneys 16 in bankruptcy court. The creditor 12 may be the entity that is owed a debt to a bankrupt customer/client who may be the debtor. The appearance attorney 16 may appear in bankruptcy court, or any other court capable of hearing a bankruptcy case, and the collection law firm 14 may be a bankruptcy law firm 14. The case and event information previously described may remain the same, but the event types could be changed to reflect event types relevant to bankruptcy proceedings such as meeting of creditors, conciliation conferences, 341 examinations, 2004 examinations, oral arguments, or evidentiary hearings. The reporting data may likewise be different and could be results such as motion granted, motion denied, order for creditor, order for debtor, or continuance. The various dashboards could be revised to reflect these events and results, and information about the time spent at the events and the attorney's narrative could continue to be gathered and tracked. The mobile application may be modified from that described with collection litigation to make it more streamlined by including only the appearance attorney 16 check in and results reporting features.

Another legal system to which the machine based system 10 can be tailored is in the field of mortgage foreclosures. The creditor 12 may be the holder of the mortgage (the mortgagee). The defendant may be a mortgagor, and the court could be any court capable of handling a mortgage foreclosure matter, and the law firm may be a mortgage foreclosure law firm 14. The case and event information previously described may remain the same as in the collection version, but the event types could be changed to reflect event types relevant to mortgage foreclosure proceedings such as oral arguments, conciliation conferences, evidentiary hearings, or sheriff sales. The reporting data may likewise be revised to reflect results that occur in mortgage foreclosure appearances such as sheriffs sales and stays of proceedings. The various dashboards could be revised to reflect these events and results specific to mortgage foreclosure, and information about the time spent at the events and the attorney's narrative could continue to be gathered and tracked. The mobile application may be modified from that described with collection litigation to include workflow that occurs in mortgage foreclosure appearances and may include items specific to this activity such as sheriff sale processes.

Another legal system to which the machine based system 10 can be tailored is in the field of structured settlements. The plaintiff, client/creditor 12 would in fact be the buyer of the structured settlement, which requires court approval, and the defendant would be the defendant in the lawsuit or the defendant's insurance company. The court could be any court capable of hearing a structured settlement matter, and the collection law firm 14 may be the same entity as the buyer of the structured settlement. The case and event information previously described may remain the same as in the collection version, but the event types could be changed to reflect event types relevant to structured settlement proceedings such as oral arguments, conciliation conferences, or evidentiary hearings. The reporting data may likewise be revised to reflect results that occur in structured appearance practice. This data may be very similar to that previously discussed with respect to the collection litigation version, but would have more detailed settlement information. The various dashboards could be revised to reflect these events and results specific to structured settlements, and information about the time spent at the events and the attorney's narrative could continue to be gathered and tracked. The mobile application may be modified from that described with collection litigation to include workflow that occurs in structured settlement appearances. Here, the mobile application modules would be more focus on settlement negotiations.

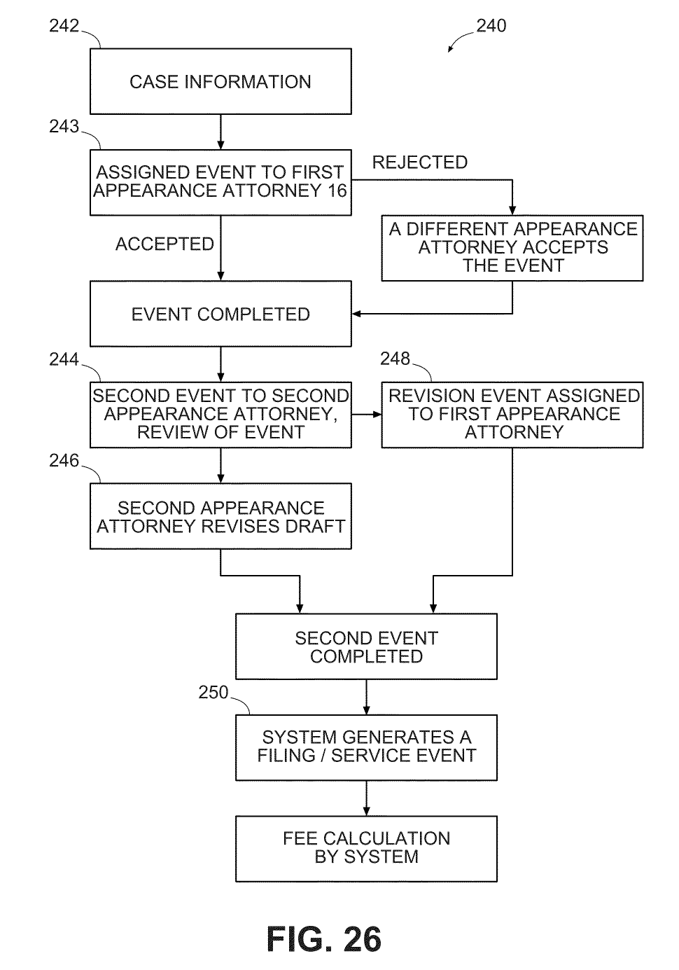

The machine based system 10 may also be utilized for legal processes that that are transactional in nature and may not include court appearances. In this regard, the appearance attorney 16 may not be an attorney that appears in court, but may be an attorney that drafts, reviews, or performs some out of court legal function. In other arrangements, the machine based system 10 may include both court appearances and transactional matters. The machine based system 10 may be used by clients 12, that may not be owed a debt, that have a need for legal work and employ collection law firm 14 that has the ability to manage legal work through a system of appearance attorneys 16. The appearance attorneys 16 may draft and file motions, briefs, and other pleadings on behalf of the client 12. The collection law firm 14 need not specifically function to collect for the client 12, but may work to perform other legal services. One example of a transactional system 240 is illustrated with reference to FIG. 26. Relevant project information such as case information 242 or information on the specific type of motion or pleading that is to be prepared can be collected from the client 12. This information could be entered into the new case screen field 60 in a similar manner as previously discussed. Next, the system 10 may assign an event 242 of the case, with an applicable deadline, to an appearance attorney 16 who has the option of accepting or rejecting the task. The event may be, for example, the preparation of a first draft of a motion or pleading. If rejected, the event may be sent to a second appearance attorney 16 for acceptance/rejection. Once this event is accepted and completed, the completing appearance attorney 16 updates the status of the event to reflect completion of the event.

The system 10 may then create a new event 244 for the case that can be described as a review of the draft created in the previously described event. This second, review event 244 may be assigned to a second appearance attorney 16 who may be given an applicable deadline. This second appearance attorney 16 may then accept or reject this second, review event. The second appearance attorney 16 may modify the draft 246, or may create a revision event 248 in the system 10 and provide requested revisions/questions back to the originally drafting first appearance attorney 16. The drafting first appearance attorney 16 can accept this event and then perform the requested revisions and update the event when completed. Either way, the second event may be completed and the system 10 updated accordingly.

The system 10 may then generate a filing/service event 250 with an applicable deadline that can be assigned to a non-attorney of the system 10 for execution. The non-attorney can accept the event 250 and complete it and then update the system 10 accordingly. This transaction system 240 arrangement may then calculate fees for the various events of the case, that can be flat fees, in a manner similar to the collection litigation system embodiment.

The transaction embodiment of the machine based system 10 may be used in legal fields such as in oil and gas legal work. Here, the events may be the preparation of title opinions and other related services in the oil and gas, or other mineral, industry. The various events may be assigned and performed in a sequential order until the case/project is complete. The first event may be a title abstract that is to be performed by a non-attorney abstractor to certain pre-defined specifications, such as the specific time-frame, by the system 10. The system 10 may catalogue each unique record into the system and track each record on a parcel basis with its relationship to other documents in the search. The second event may be title review and opinion that is performed by a first appearance attorney 16. This second event may include a written opinion and records for each title contingency that is identified.

The third event that can be assigned by the system 10 may be quality control review of the title opinion and contingencies, and this even may be assigned to a different, second appearance attorney 16. A fourth event of the system may be the review of opinion and waiver of select contingencies by the client 12. Finally, a fifth event may be curative tasks to be assigned and performed by a non-attorney landman for each of the title contingencies that are not waived by the client 12. The events may be performed in the order given, and they can be marked as completed by the performer in the system 10. The system 10 may provide progress updates to the client 12 when each one of the events is completed. The different users performing the stated events may be in communication with one another when the events are being performed, and two or more of the events may be performed in certain arrangements. The system 10 allows for high volume completion of legal services in allowing a remote workforce to collaborate with one another, thus allowing the collection law firm 14 or client 12 to work more efficiently.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

1. A machine based system for a legal process, comprising:
a memory for storing an event;
an alarm component for sending an alarm related to the event; and
a processor for obtaining an outcome of the event and assigning the outcome of the event to the event, wherein the outcome of the event is selected from a group of outcomes comprising:
motion granted,
draft completed,
review of draft completed, and
filing completed.

2. The machine based system as set forth in claim 1, further comprising a display, wherein the group of outcomes is displayed on the display in a list for selection;
wherein the group of outcomes further comprising:
motion denied,
judgment for plaintiff,
settlement agreement without judgment,
continuance,
judgment for defendant,
consent judgment without payment plan, and
consent judgment with payment plan.

3. The machine based system as set forth in claim 2, wherein the continuance outcome is assigned to the event, wherein a new event is stored in the memory after the continuance outcome is assigned to the event, wherein information assigned to the event is assigned to the new event by the processor, wherein the new event includes information regarding whether a request for continuance needs to be filed with the court.

4. The machine based system as set forth in claim 1, wherein the settlement agreement without judgment outcome is assigned to the event, wherein the processor assigns whether money due is a lump sum or a payment plan to the event, wherein the processor assigns a due date to the event, and wherein the processor assigns whether a payment was received.

5. The machine based system as set forth in claim 1, wherein the draft completed outcome is assigned to the event, wherein the legal process is transactional legal work without any court appearances, wherein the memory stores a second event that is a draft revision event, wherein the processor obtains an outcome for the second event and assigns the outcome of the second event to the second event, wherein the outcome of the second event is revision of draft completed.

6. The machine based system as set forth in claim 1, wherein the event is changed in the memory, wherein the alarm component sends the alarm when the event is changed in memory before the outcome of the event is assigned to the event.

7. The machine based system as set forth in claim 1, wherein the draft completed is assigned to the event, wherein the event is a title abstract, wherein the memory stores a second event that is a title review and opinion, wherein the processor obtains an outcome for the second event and assigns the outcome of the second event to the second event, wherein the outcome of the second event is title review and opinion completed,
wherein the memory stores a third event that is a quality control review of title opinion and contingencies, wherein the processor obtains an outcome for the third event and assigns the outcome of the third event to the third event, wherein the outcome of the third event is quality control review of title opinion and contingencies completed.

8. The machine based system as set forth in claim 1, wherein the event is assigned to an attorney, wherein the attorney accepts the event, wherein a status of the event is updated to accepted upon the acceptance of the event by the attorney, wherein a client of the machine based system is informed that the event has been accepted.

9. A machine based system for a legal process, comprising:
a memory for storing an attorney appearance package of an appearance attorney, wherein the attorney appearance package has a case coversheet that identifies a plaintiff, a defendant, and a court,
wherein the attorney appearance package has an appearance document,
wherein the attorney appearance package has a case attachment;
a processor that assigns the appearance document to the attorney appearance package; and
a GPS component that sends information on a location of the GPS component that corresponds to a location of the appearance attorney.

10. The machine based system as set forth in claim 9, wherein the appearance document is a settlement agreement, and wherein the case attachment is a credit card statement of a debtor, and wherein the attorney appearance package is assigned to an event by the processor.

11. The machine based system as set forth in claim 9, further comprising paper onto which the attorney appearance package is printed; and
wherein the attorney appearance package is assigned to an event by the processor, wherein the event is capable of being identified as completed only upon proper information provided by the GPS component.

12. The machine based system as set forth in claim 9, wherein the memory stores a plaintiff profile that has settlement authority, wherein the plaintiff profile has a default appearance document that is assigned by the processor to be the appearance document of the attorney appearance package, and wherein the plaintiff profile has a document retention policy.

13. The machine based system as set forth in claim 9, wherein the plaintiff is selected from the group consisting of a creditor, a bankruptcy creditor, a mortgagee, and a buyer of a structured settlement;
wherein the defendant is selected from the group consisting of a debtor, a bankruptcy debtor, a mortgagor, and an insurance company; and
wherein the court is selected from the group consisting of a court of common pleas, a bankruptcy court, a court capable of handling mortgage foreclosures, and a court capable of handling structured settlements.

14. A machine based system for litigation, comprising:
a memory for storing settlement authority;
a processor for accepting input on whether a settlement offer was accepted, wherein the processor causes the decision on whether the settlement offer was accepted to be stored in the memory;
a display that displays the settlement authority; and
a camera that captures an image of a document, wherein the image of the document is stored in the memory.

15. The machine based system as set forth in claim 14, wherein the memory stores a correct party acknowledgement, appearance attorney instructions for guidance in proper procedures during the litigation, and adverse party acknowledgement.

16. The machine based system as set forth in claim 14, wherein the processor accepts input on whether a counter offer of the settlement offer was accepted, wherein the processor generates a settlement agreement that is displayed on the display, wherein the processor accepts acknowledgement of the settlement agreement and stores acknowledgement of the settlement agreement in memory.

17. The machine based system as set forth in claim 14, wherein an appearance attorney check in page is displayed on the display, further comprising a GPS component that sends information on a location of the GPS component that corresponds to a location of the display, wherein the processor receives input that the appearance attorney is physically located at a scheduled hearing location, wherein the processor receives the location information of the display and uses this information to verify the physical location of the appearance attorney at the scheduled hearing location.

18. The machine based system as set forth in claim 14, wherein the display displays a defense attorney information page, wherein the processor accepts input of the name of a defense attorney, a phone number of the defense attorney, and an address of the defense attorney.

19. The machine based system as set forth in claim 14, wherein the display is part of a mobile device that has the camera, wherein the document is a settlement document that is signed after the settlement offer is accepted.

20. The machine based system as set forth in claim 14, wherein the display is part of a mobile device, wherein the processor is a collection processor that is part of a collection litigation server, wherein the memory is a collection memory that is part of the collection litigation server.

21. The machine based system as set forth in claim 14, wherein the memory includes an appearance attorney overall positive disposition rate, an appearance attorney overall judgment rate, an appearance attorney overall settlement rate, an appearance attorney total dollar amount of judgments in the last twelve months, an appearance attorney total dollar amount of settlements in the last twelve months, an appearance attorney number of events in the last twelve months, and an appearance attorney number of courts in the last twelve months;
wherein the display displays an attorney dashboard that includes the appearance attorney overall positive disposition rate, the appearance attorney overall judgment rate, the appearance attorney overall settlement rate, the appearance attorney total dollar amount of judgments in the last twelve months, the appearance attorney total dollar amount of settlements in the last twelve months, the appearance attorney number of events in the last twelve months, and the appearance attorney number of courts in the last twelve months.
